(19) United States
(12) Patent Application Publication
(10) Pub. No.: US 2026/0154920 A1
(43) Pub. Date: Jun. 4, 2026

(54) SIMULATING DIFFERENTIABLE OBJECT ELASTICITY USING IMPLICIT FUNCTIONS

(71) Applicant: Nvidia Corporation, Santa Clara, CA (US)

(72) Inventors: Gilles Daviet, Mures (FR); Tianchang Shen, Toronto (CA); Nicholas Sharp, Seattle, WA (US); David I.W. Levin, Toronto (CA)

(21) Appl. No.: 18/964,285

(22) Filed: Nov. 29, 2024

(51) Int. Cl. G06T 19/20

(52) U.S. Cl. CPC G06T 19/20; G06T 2219/2021

(57) ABSTRACT

Approaches presented herein provide for the use of implicit functions to simulate differentiable object elasticity. An implicit continuous function, such as a signed distance function (SDF), can be used to approximate the surface of an object by providing scalar values from a set of vertices of a regular grid in which the object representation is to be generated. Interpolation can be applied to determine an approximate surface location and shape within each boundary cell. A trained neural network, such as a multilayer perceptron (MLP), can be used to determine appropriate quadrature points that fall within the volume of the object. A finite element analysis can integrate over these quadrature points, using both continuous and discrete settings, as a basis for performing efficient differentiable elasticity simulations including the deformable object.

### BACKGROUND

There are a variety of applications—such as for physical component simulation or realistic video rendering—where it is desirable to render virtual or digital representations of real world objects with an accurate appearance and physical behavior. This includes not only generating a reconstruction of the object that is accurate in shape, size, and appearance, but also ensuring that the object reconstruction is physically sound. Prior approaches typically start from an explicit boundary mesh for one or more objects, and generate a volumetric mesh to use to perform a simulation. Unfortunately, generating a sufficiently high quality volumetric mesh for just one object can be time consuming and costly, let alone for a scene with multiple objects. This is particularly true for elastic or deformable objects that may change shape over time, and may thus require almost continual expensive reconstruction of these volumetric meshes. Prior approaches to reduce this expense proved to still be quite costly while also not being easily differentiable or well-suited for optimization of deformable topology.

### BRIEF DESCRIPTION OF THE DRAWINGS

Various embodiments in accordance with the present disclosure will be described with reference to the drawings, in which:

FIG. 1 illustrates components of an example system that can be used to simulate differentiable object elasticity, according to at least one embodiment;

FIGS. 2A, 2B, and 2C illustrate simulated states of a representation of an object, according to at least one embodiment;

FIG. 3A illustrates a grid view of a portion of an object representation, according to at least one embodiment;

FIG. 3B illustrates example quadrature points that can be selected for a boundary cell, according to at least one embodiment;

FIG. 3C illustrates an example set of scalar values from boundary cell vertices that can be used to approximate the location of a portion of an object surface within a cell, according to at least one embodiment;

FIGS. 4A, 4B, and 4C illustrate example quadrature points located inside the volumes of object with different shapes and/or orientations, according to at least one embodiment;

FIG. 5 illustrates an example process that can be performed to approximate an exponential function, according to at least one embodiment;

FIG. 6 illustrates components of a distributed system that can be utilized to generate and provide image content generated using function approximation according to at least one embodiment;

FIG. 7A illustrates inference and/or training logic, according to at least one embodiment;

FIG. 7B illustrates inference and/or training logic, according to at least one embodiment;

FIG. 8 illustrates an example data center system, according to at least one embodiment;

FIG. 9 illustrates a computer system, according to at least one embodiment;

FIG. 10 illustrates a computer system, according to at least one embodiment;

FIG. 11 illustrates at least portions of a graphics processor, according to one or more embodiments;

FIG. 12 illustrates at least portions of a graphics processor, according to one or more embodiments;

FIG. 13 is an example data flow diagram for an advanced computing pipeline, in accordance with at least one embodiment;

FIG. 14 is a system diagram for an example system for training, adapting, instantiating and deploying machine learning models in an advanced computing pipeline, in accordance with at least one embodiment; and

FIGS. 15A and 15B illustrate a data flow diagram for a process to train a machine learning model, as well as client-server architecture to enhance annotation tools with pre-trained annotation models, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles or machines, semi-autonomous or autonomous vehicles or machines (e.g., in one or more advanced driver assistance systems (ADAS), one or more in-vehicle infotainment systems, one or more emergency vehicle detection systems), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, generative AI, model training or updating, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), collaborative content creation for three-dimensional (3D) assets, generative artificial intelligence (AI), cloud computing, and/or any other suitable applications.

Disclosed embodiments may be comprised in a variety of different systems such as automotive systems (e.g., an in-vehicle infotainment system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models—such as large language models (LLMs), vision language models (VLMs), multi-modal language models, etc., systems for performing generative AI operations (e.g., using one or more language models, transformer models, etc.), systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

Approaches in accordance with various illustrative embodiments allow for an efficient physics-based simulation of deformable objects. A distance function (e.g., a signed distance function (SDF)) can be used to implicitly define the surface of an object in 3D space, with the surface corresponding to points where the value of the distance function is zero, such that the point is neither inside nor outside the object but instead lies along the surface. If the 3D space is defined by a 3D grid of cells, various cells will either be fully inside or outside the surface of the object, while some boundary cells will contain a respective portion of the object surface. For those boundary cells that contain a portion of the surface, the approximate shape and location of the surface inside that cell can be inferred using a set of scalars—one from each vertex of the cell. The number of scalars can thus depend in part upon the shape or type of cell, such as where eight scalars may be generated for the eight vertices of a cubic cell, or six scalars for the six vertices of an octahedral cell, among other such options. Interpolation or other such processing can then be performed to approximate the surface based on these points within the boundary cells. In order to integrate over only the portions of these cells that contain (portions of) the objects, a machine learning model such as a multilayer perceptron (MLP) can be used to infer appropriate locations (and weights) for each of a set of quadrature points, such that those quadrature points will fall within the volume (or inside the surface) of the object based in part on the scalars associated with the cell vertices. These “adapted” quadrature points can be used to evaluate integrals and perform a finite element simulation or analysis. A finite element simulation can be appropriate due to the fact that there may be significantly different stiffness or elasticity values across the surface of the object being simulated. Such an approach can allow for approximating the geometry of an object from a numerical integration formula rather than a conforming geometric mesh, avoiding the need to modify the geometric mesh for each change to the object being simulated. Standard finite element simulation can be performed once the appropriate quadrature points are determined.

Variations of this and other such functionality can be used as well within the scope of the various embodiments as would be apparent to one of ordinary skill in the art in light of the teachings and suggestions contained herein.

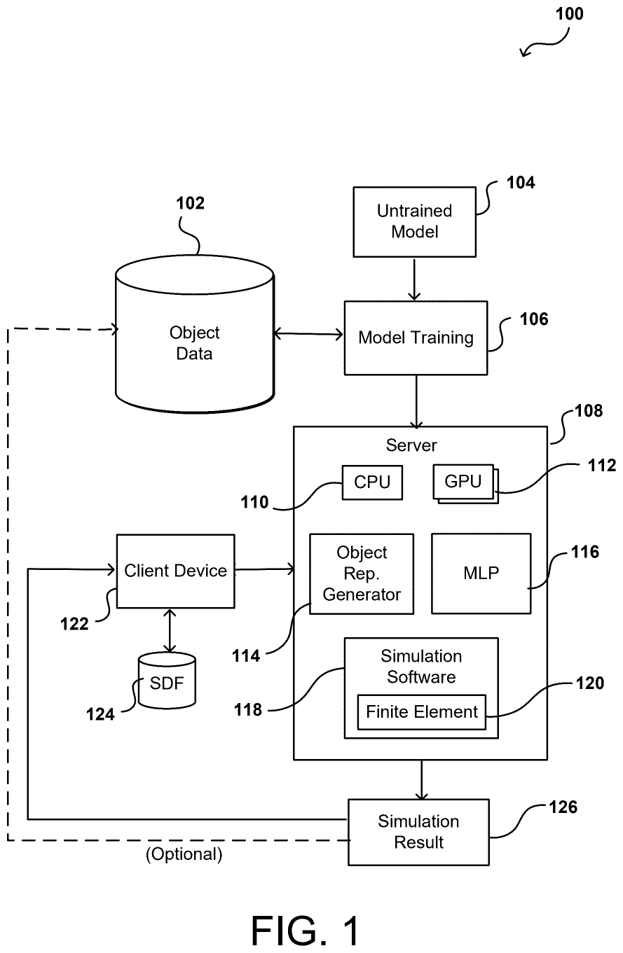

Approaches in accordance with at least one embodiment can generate and/or render virtual or digital representations of objects (e.g., real or synthetic objects) that have a realistic appearance and/or behavior. FIG. 1 illustrates an example system 100 that can be used to perform digital reconstruction of one or more objects according to at least one embodiment, where the reconstruction of those objects is both accurate in appearance and physical behavior. In at least one embodiment, this can be accomplished by using machine learning (e.g., a generative neural network) to generate the reconstruction, and adding a physics-aware loss term in a corresponding shape reconstruction optimization routine.

In the example system of FIG. 1, simulation software 118 can be used to perform simulation with respect to one or more digital representations of physical objects. This can include performing differentiable simulations on evolving domains, such as deformable objects, with accurate physical behavior. One approach that can be used for such simulation involves integrated finite element analysis, as will be discussed in more detail later herein. In order to allow for accurate integration, it can be beneficial to determine points, such as quadrature points, that are located within the volume of the objects and can provide accurate integration over location and weights of those quadrature points. In an example where there is not an explicit input representation, however, it can be difficult to determine accurate quadrature points to use for the analysis. In a system such as that illustrated in FIG. 1, a machine learning model can be trained to identify appropriate quadrature points that fall within the surface of an object and allow for accurate integration for the finite element analysis. In this example, a model training module 106 can take an untrained model 104, such as an untrained (or at least unrefined) multilayer perceptron (MLP), and can train that MLP using a repository 102 of object data (real and/or synthetic) so that a trained MLP 116 can be used to determine appropriate, if not “optimal,” locations for quadrature points inside an object based on a signed distance function, for example. The results can then be provided for use in simulation.

In the example system 100 of FIG. 1, a client device 122 may select a signed distance function (SDF) 124 (or other functional representation of an object) and provide that SDF 124 for use in a simulation. In this example, the client device 122 can provide the SDF in a request sent to a server 108, such as a cloud server hosted in a remote data center, which has greater capacity and resources to perform resource-heavy tasks such as inferencing and simulation. It should be understood, however, that in other embodiments, at least some of this functionality could be performed on the client device 122 (or another such system or component) as well. In this example, the server 108 to be used to perform the simulation can include at least one central processing unit (CPU) 110 to process the request, and at least one graphics processing unit (GPU) 112 or other such processing unit (e.g., a data processing unit (DPU) or tensor processing unit (TPU), among other such options) to perform specific tasks with respect to the simulation. In this example, the SDF 124 can be directed to an object representation generator 114 which can attempt to determine a volumetric representation of the object from the values of the SDF. This can include, for example, generating a representation of the object using a regular grid, where scalar values can be determined for vertices of the cells of the grid that provide an approximate location of the surface of the object in various cells. The object representation generator 114 in this example can work with a trained MLP 116 to determine appropriate quadrature points for the grid, attempting to ensure that the points fall within the volume of the object. The MLP in this example (e.g., an MLP with 5 layers MLP and width 64) can smoothly predict integration point weights and locations as a function of the implicit values at each grid vertex. The object representation, including the quadrature points and respective weights, can then be provided to the simulation software 118. The simulation software 118 can provide a simulation environment, and can use a finite element solver 120 or other such element or process to perform a number of physics-based simulations as discussed herein. One or more simulation results 126 can then be provided back to the client device 122. In some embodiments, at least some of the simulation results may optionally be stored to the object data repository 102 as additional training data for use in further training the MLP (or for other such purposes). In some embodiments, the results may be stored to a result repository or log database, among other such options. In at least one embodiment, a high-order mixed finite element solver can be used to solve for non-linear elasticity, to create an end-to-end, differentiable, nonlinear elasticity simulation for shape, topology and material optimization. Such an approach can help to obtain high levels of accuracy of finite-element integration on such deformable geometries without the need for explicit meshing. The MLP can generate quadrature points that help to make the integration result differentiable with respect to the discrete SDF values stored on the grid, enabling gradient-based topology optimization (i.e., optimizing the material geometry such that it optimizes a physics-based loss function).

A system 100 such as that illustrated in FIG. 1 may generate digital reconstructions of a wide variety of types of objects for any of a number of different purposes or operations, as may relate to real world simulations, animations, gaming, automated environment interaction, and virtual/augmented/enhanced reality, among other such options. In such operations, it can be desirable or even necessary to ensure that the representation of a given object is accurate in size, shape, and physical behavior, in addition to appearance, sound, or other such perception aspects. As mentioned, approaches in accordance with at least one embodiment can use discrete signed distance fields (SDF) to represent complex volumetric objects in computer graphics. In order to allow for accurate physical behavior, the representation also has to account for the deformability of the shape or other such variable aspects of an object, whether through motion, bending, stretching, or other such motions. In order to ensure the deformability is realistic, however, the representation also needs to account for the physical properties, capabilities, or limitations of the object, such as, for example and without limitation, the response to elastic stress or compression.

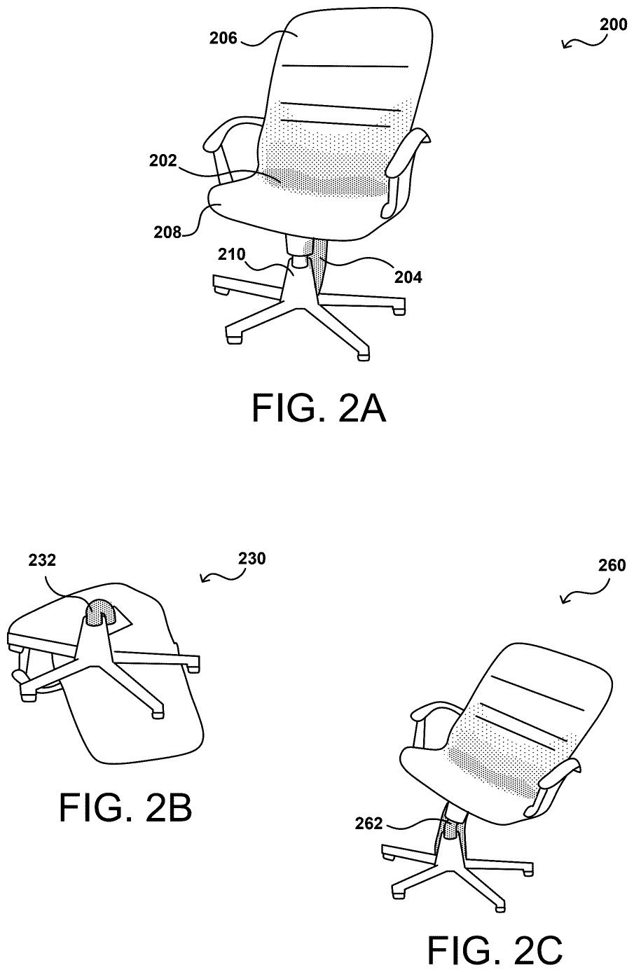

Consider an example chair 200 illustrated in FIG. 2A. In this example, the representation includes an accurate shape and appearance of a type of chair. In the physical world, there would be forces applied to this chair when a person is interacting with the chair, and those forces would be applied differently in different locations, which can result in different deformations of the chair. For example, there is a region 202 of the chair near where the back 206 of the chair meets the seat 208, which will experience force and potential deformation in response to a user pushing or leaning back on the back 206 of the chair. Similarly, there is a region 204 under the seat 208 that will experience force and potential deformation if the chair has a setting to allow the seat 208 to adjust orientation relative to the base 210 of the chair, such as to allow a person to lean the seat 208 back so the seat 208 is at an angle relative to the floor.

If a representation allows for such deformability, but does not represent accurate physical behavior, then unrealistic actions or appearances can occur. For example, FIG. 2B illustrates an example view 230 of a chair where a force has been applied to the back of the chair, and a flexible base connection portion 232 has allowed the back and seat to change orientation with respect to the base. As illustrated, however, the behavior of the chair is not realistic as the chair is illustrated such that the seat portion rotated about 180 degrees from its original position, which would not be possible for a conventional physical chair having a typical force attached. Due to the physical characteristics and limitations of a physical chair, having such a force applied might more realistically result in a state of the chair as illustrated in the example view 260 of FIG. 2C. In this example, the force has resulted in the seat of the chair changing angle with respect to the base, but the deformable or flexible member 262 only bends up to a maximum amount. Such a physical property can be desirable so that a person cannot lean too far back or over and cause the chair to deform to an extent that the person might fall out of the chair. While it would be possible to hard code rules or limits on the deformation of the chair, to prevent deformation as illustrated in FIG. 2B, such rules are time consuming and costly to generate and implement, and still do not reflect an accurate physical behavior of the chair, such as how quickly the chair may move, how that movement rate varies with angle, and the like.

Approaches in accordance with various embodiments can attempt to train a generative model to learn this accurate physical behavior, including properties such as force distribution, elasticity, deformability, compressibility, and the like. If a person is sitting in a chair and not sitting still, the chair may be almost continually deforming in shape. Algorithms for simulating elasticity on evolving domains can be important for tasks such as shape editing, design, and optimization. Evolving surfaces are often handled by some combination of surface tracking explicit representations and implicit methods. Coupling evolving surfaces back to a volumetric elasticity simulation can be accomplished through a volumetric remeshing or the use of non-conforming meshes and careful volumetric integration and boundary condition handling.

In physics-based shape optimization problems, such as topology optimization, various existing schemes rely on a fixed simulation mesh, and embed the evolving surface as either a level set or a density field. Unfortunately, these domain integrals required are difficult to process as integrals over binary density representations are not strictly differentiable and require mollification, and integrals over immersed boundaries can become ill-conditioned, causing noisy results.

Approaches in accordance with at least one embodiment take an embedded surface approach, where an evolving or deformable surface is represented as a set of dynamic implicit function values (signed) on the vertices of a grid. Relying on an implicit shape representation allows a system (such as that illustrated in FIG. 1) to seamlessly handle evolving geometry with both shape and topology changes, without relying on complex remeshing schemes. A machine learning-based solution can be used for at least the volumetric integration problem, such as where a neural network can be trained to smoothly predict integration point weights and locations as a function of the implicit values at each grid vertex. A high-order mixed finite element solver for non-linear elasticity can also be used to create an end-to-end, differentiable, nonlinear elasticity simulation for shape, topology and material optimization. Such an approach can be directly combined with a variety of different shape and geometry reconstruction pipelines, supporting a variety of operations as may relate to shape- and image-guided topology optimization. Such an approach can also provide benefits for operations relating to forward simulations and manual shape editing tasks, among other such operations.

In at least one embodiment, an object reconstruction system can benefit from an in-the-loop physics simulator. Such a simulator can attempt to determine and apply accurate physics in object reconstruction. This can include, for example, performing a quasi-static simulation for at least one (e.g., each) sequence of optimizer iterations. In at least one embodiment, such a simulator can provide for fast initialization of a simulation by, in part, not performing explicit volumetric meshing as in prior approaches. Such a simulation can also be allowed to operate on non-converted reconstruction tasks, allowing for robustness of simulation to unexpected, irregular, or otherwise “weird” geometry inputs. Such a simulation can also be differentiable with respect to material parameters, as well as with respect to object shape and topology.

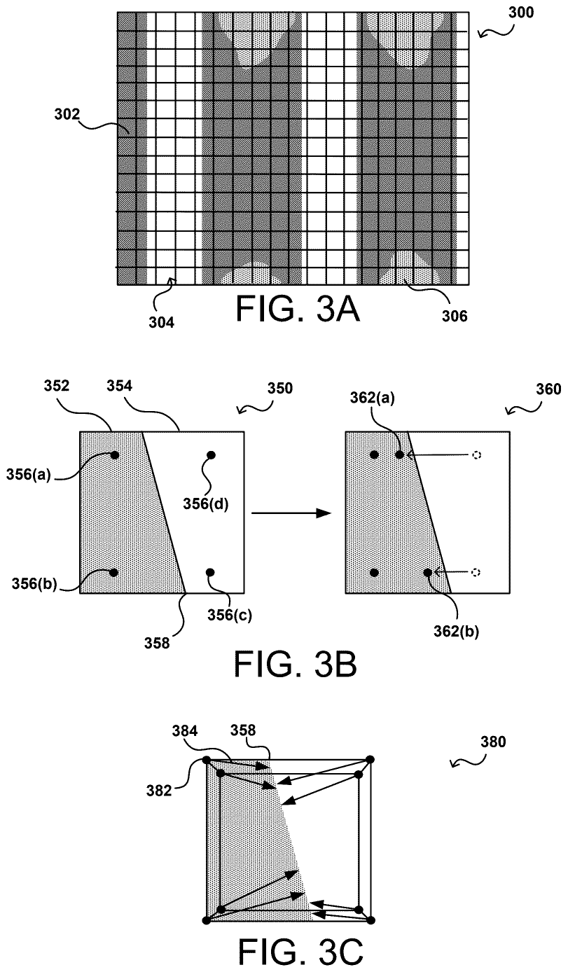

In at least one embodiment, a simulation can be performed with respect to a sparse regular hexahedral grid 300, such as is illustrated in FIG. 3A. This example grid 300 (represented in 2D for ease of illustration) includes dark regions 302 that correspond to portions of an object, and light regions 304 that are outside the surface of the object. In this example, this view might correspond to slats in the back of a wooden chair. As illustrated, there may also be regions 306 with different shading representing portions of the object that are deformable or where significant force may be applied, such as was discussed with respect to the chair illustrated in FIG. 2A. As illustrated in the example grid view, there will be certain cells that fall within the surface of the object and that are completely shaded. There will also be certain cells that fall outside the surface of the object, and that are completely unshaded. There will also be certain cells that are partially shaded and partially unshaded, indicating that at least a portion of the outer surface of the object passes through that cell. In at least one embodiment, there can be tendrils or other connectors between cells including object portions or material regions. These tendrils can be used to define the physical properties or relationships between pairs of cells, as discussed in more detail elsewhere herein. Approaches provided herein allow for simulating relatively fine tendrils using relatively coarse grids for the simulation structure.

In such an example, the object of the surface is not explicitly defined, but constitutes an implicitly-defined volume determined using a discrete SDF. The object can be simulated and/or reconstructed using a grid, such as a sparse regular hexahedral grid. Using such a definition, there is no need for a conforming volumetric mesh, and cells in the interior of the object do not require any special treatment. In at least one embodiment, a surface determination process can analyze the cells of the grid that are determined to include a surface portion, or that have a portion of the interior of the cells within the interior of an object, and a portion outside the surface of the object. As an example, a first view 350 of an example cell illustrates a first shaded portion 352 that falls inside the surface of an object, and a second unshaded portion 354 that falls outside the surface of the object. In order to determine where the surface 358 of the object falls within that cell, a set of sampling or “quadrature” points 356(a)-(d) can be selected and analyzed to determine whether they fall within the surface. An approach such as adaptive numerical integration can then be performed over these quadrature points of the various boundary cells containing a portion of a surface of at least one object. For example, the distance values from the continuous signed distance function can be used to determine whether various points are inside or outside the surface of a given object. Based in part on the location of these points inside or outside the surface, an approximate representation of the volume can be determined, and a mesh constructed that corresponds to the surface or volume of the object. In a conforming reconstruction, an attempt can be made to have the approximating polynomials (determined using these discrete elements) match the boundary of the object mesh as closely as possible. It, therefore, can be desirable in at least one embodiment to define one or more polynomial functions that, when integrated, provide the same result as if iterating over an actual geometric surface mesh. In other words, instead of adapting a mesh to the geometry of an object, such an approach can adapt the numerical integration formula such that when integrating over a non-conforming cell, the non-conforming cell behaves as if it were a conforming cell.

It would be possible to integrate a function over an entire cell using the sampled quadrature points 356(a)-(d), as the integration for a function sampled exactly at those points will involve quadratic polynomials. Such an approach results in integrating over the entire cell, however, instead of integrating over the portion 352 that corresponds to the object. Approaches in accordance with at least one embodiment can instead attempt to determine quadrature points that fall inside the surface of the object, or are contained within an interior portion of the object. This can include, for example, “moving” the quadrature points to locations inside the object, or determining new or alternative quadrature points 362(a), (b) that are inside the object as illustrated in the view 360 on the right of FIG. 3B. Such movement or improved selection of quadrature points can effectively reduce the diameter and/or weights corresponding to the object inside the cell, with the sum of the weights corresponding to the object portion 352 instead of the entire cell. By adapting with integration points, a non-confirming mesh can be used with the corresponding function integrated as if the process were integrating over the actual geometry (or object portion 352) within the cell.

In at least one embodiment, a machine learning model such as an MLP can be used to infer appropriate quadrature points. Each vertex point 382 corresponding to a corner of a cell, as illustrated in the cell view 380 of FIG. 3C, can have a scalar 384 determined using the signed distance function. A given scalar can include a direction and magnitude from a given vertex 382 to a point on the surface 358 of the object, typically the point corresponding to the shortest distance to the surface within the cell. For a cell such as that illustrated in FIG. 3C, there will be eight such scalars, defining eight points along the object surface. As mentioned, there may be other numbers of scalars generated for other types of cells with a different number of vertices. These points can be used (with interpolation or other such functions) to determine the approximate object shape and location within the cell. In some embodiments, positive distance can correspond to regions inside the object and negative distance values can correspond to regions outside the object surface (or vice versa), with the position of the surface corresponding to the location where the distance values from the SDF are 0, or are neither positive nor negative. For objects with complex surfaces, it may be beneficial to use smaller cells or a finer grid of cells in order to keep the portion of a surface within a given cell relatively simple to allow a reasonable approximation to be made using eight points (or another corresponding number for other types of cells with different numbers of vertices). A portion of an object surface location within a cell can be approximated using scalars 384 as illustrated in FIG. 3C, where those scalars are determined using an SDF, and an MLP can take the SDF as input and effectively use these scalars to determine quadrature points that fall within the interior of the object, as illustrated in the righthand cell view 360 of FIG. 3B. Each quadrature point will have an associated weight as discussed, and the value of that weight will change based in part upon the placement of a given quadrature point. In at least one embodiment, it can be important to select quadrature points that are inside the object so that when performing an operation such as finite element analysis, the integrals are being evaluated only over the domain of the object geometry. Attempting a simulation with quadrature points outside the object or low quality weights can cause a simulation to “blow up” or otherwise go in unintended directions yielding potentially useless results. In at least one embodiment, a neural network such as an MLP (or other such network) can be trained to output quadrature points that are determined to be most optimal given the discrete SDF values on a hexahedral grid. The network needs only to be trained once for a given integration order, and can then be evaluated once for each cell at the start of the simulation. Such an approach is highly accurate while being fast and computationally efficient, inheriting the inherent differentiability of the neural network.

As mentioned, once appropriate quadrature points are determined by an MLP using an SDF, for example, those quadrature points can be used to perform a simulation using an operation such as finite element analysis. In at least one embodiment, a finite element method (FEM) solver can be used in both continuous and discrete settings to serve as a basis for differentiable elasticity simulations. FEM is a numerical technique that solves differential equations by breaking a complex system or problem into smaller (or “finite”) elements and applying differential equations to each of these elements individually using discretization. For explanation, V_{Ω} can be used to denote the space of square-integrable [symbol] ³-valued fields over Ω with square-integrable derivatives, and T_{Ω} used to denote the space of square-integrable 3×3 tensor fields. Parameters SO_{Ω}, Sym_{Ω}, and Skew_{Ω}, represent the subspaces of T_{Ω} whose values are rotations, symmetric tensors, and skew-symmetric tensors, respectively.

Using such notation, the kinetic and potential energies of the system can be given by:

$${E}_{k} = {\int }_{Ω} {ρ ù}^{2} , {E}_{p} : = ψ ( F ( u ) ) - {\int }_{Ω} ρ u . g , ψ ( S ) : = {\int }_{Ω} Ψ ( S )$$

with the deformation gradient F(u):= [symbol] ₃+∇u, and Ψ: [symbol] ^{3×3}→ [symbol] representing the local elasticity potential. Lagrange dynamics then state that

$$\frac{d}{dt} \frac{\partial {E}_{k}}{\partial ù} + \frac{\partial {E}_{p}}{\partial u} = 0 .$$

Using an implicit Euler integrator with timestep Δₜ (possibly infinite in the quasistatic limit), such that:

$$ù ∼ \frac{u - {u}^{n}}{{Δ}_{t}} ,$$

the conservation of momentum over the timestep can be rewritten as the minimization of the incremental potential:

$${min}_{u ∈ {V}_{Ω}} ψ ( F ( u ) ) + \frac{1}{2} a ( u , u ) - b ( u )$$

$$a ( u , v ) : = {\int }_{Ω} \frac{ρ}{{Δ}_{t}^{2}} u \cdot v ,$$

$$b ( v ) : = {\int }_{Ω} ρ ( g + \frac{1}{{Δ}_{t}^{2}} {u}^{n} ) \cdot v$$

A mixed FEM approach can be used to address such minimization by splitting the objective function into three variables:

$$u ∈ {V}_{Ω} , S ∈ S y {m}_{Ω} and R ∈ {SO}_{Ω}$$

with the constraint that C(u, R, S):=F(u)−RS=0. The first problem then becomes equivalent to finding a saddle point of the associated Lagrangian, as may be given by

$${min}_{u ∈ {V}_{Ω} , S ∈ {Sym}_{Ω} , R ∈ {SO}_{Ω}} {max}_{σ ∈ {T}_{Ω}} ℒ ( u , S , R , σ ) ,$$

$$ℒ ( u , S , R , σ ) : = \frac{1}{2} a ( u , u ) + b ( u ) + Ψ ( S ) + c ( u , S , R , σ ) ,$$

$$c ( u , S , R , σ ) : = {\int }_{Ω} C ( u , R , S ) : {σ}^{T} .$$

The saddle point condition ∂ [symbol] =0 reads:

$$a ( u , v ) + c , u ( v , σ ) - b ( v ) = 0 ∀ v ∈ {V}_{Ω}$$

$$ψ ( S ; τ ) + c , S ( R ; τ , σ ) = 0 ∀ τ ∈ S y {m}_{Ω}$$

$$c , R ( S ; τ , σ ) = 0 ∀ Q ∈ {SO}_{Ω}$$

$$c ( u , R , S , λ ) = 0 ∀ λ ∈ {T}_{Ω} .$$

Where the forms ψ, s and c, q are Gâteaux derivatives, i.e,

$$ψ , S ( S ; τ ) : = {\int }_{Ω} \frac{\partial Ψ}{\partial S} ( S ) : τ , c , u ( u , λ ) : = {\int }_{Ω} ∇ u : {λ}^{T} ,$$

$${c}_{, R} ( S ; R , λ ) : = {\int }_{Ω} RS \text{:} {λ}^{T} , {c}_{, S} ( R ; S , λ ) : = {\int }_{Ω} RS : {λ}^{T} .$$

It can be noted that up to a non-zero stress boundary condition, is not employed in at least one embodiment, σ corresponds to a Cauchy stress tensor. While in at least one embodiment σ is not explicitly enforced to be symmetric, the conditions set forth above can ensure that the skew part of σ is zero as long as S is non-singular.

The system set forth above can be solved using projected Newton iterations to solve for the step direction:

$$( δ u , δ S , δ R , δσ )$$

$$δR ∈ S k e {w}_{Ω}$$

$${R}^{k + 1} = {R}^{k} + {R}^{k}$$

Linearizing the residual around the current iterate (u^{k}, S^{k}, R^{k}, σ^{k}) yields the linear forms:

$${ψ}_{, S}^{k} := ψ , S ( {S}^{k} ; \cdot ) , {c}^{k} := c ( {u}^{k} , {S}^{k} , {R}^{k} , \cdot )$$

And the bilinear forms:

$${c}_{, S}^{k} := {c}_{, S} ( {R}^{k} ; \cdot , \cdot ) ,$$

$${c}_{, R}^{k} ( δ R , λ ) := {\int }_{Ω} {R}^{k} δ {RS}^{k} : {λ}^{T} and$$

$${h}^{k} ( δ S , τ ) := {\int }_{Ω} δ S : \prod ( \frac{{\partial }^{2} Ψ}{\partial {S}^{2}} ( {S}^{k} ) ) : τ$$

where the Π operator makes the hessian of Ψ positive definite.

To help with convergence, a numerical regularization term can be introduced on the rotation update δR through a last bilinear form defined on:

$${Skew}_{Ω}^{2} , ϵ ( δ R , ω ) := ε {\int }_{Ω} δ R : ω$$

with ε>0 an arbitrary coefficient chosen to be small with respect to the typical inertia

$$ρ {L}^{2} / {Δ}_{t}^{2} .$$

It can be noted that this term does not change the solution to the nonlinear root-finding problem, but can improve the conditioning of one or more intermediate systems.

At each Newton iteration, a solution can be determined using:

$$a ( u + δ u , v ) + {c}_{, u} ( v , {σ}^{k} + δσ ) = b ( v ) \qquad ∀ v ∈ {V}_{Ω}$$

$${h}^{k} ( δ S , τ ) + {c}_{, S}^{k} ( τ , {σ}^{k} + δσ ) = - {ψ}_{, S}^{k} ( τ ) \qquad ∀ τ ∈ {Sym}_{Ω}$$

$$ϵ ( δ R , ω ) + {c}_{, R}^{k} ( ω , {σ}^{k} + δσ ) = 0 \qquad ∀ ω ∈ {Skew}_{Ω}$$

$$\begin{matrix}{c}_{, u} ( δ u , λ ) + {c}_{, S}^{k} ( δ S , λ ) + {c}_{, R}^{k} ( δ R , λ ) = - {c}^{k} ( λ ) & ∀ λ ∈ {T}_{Ω}\end{matrix} .$$

In at least one embodiment, a Newton loop can be equipped with a backtracking line-search for computing the step size. As equality-constrained optimization is being performed, however, it may not be possible to enforce iterates to remain feasible and simply use the incremental potential as the objective function. Instead, an approach in accordance with at least one embodiment can adopt the merit function

$$ϕ ( u , S , R ) := \frac{1}{2} ( u , u ) - b ( u ) + ψ ( S ) + ξ {\int }_{Ω} ‖ C ( u , R , S ) ‖ ,$$

with ξ a penalty coefficient chosen as

$$ρ {L}^{2} / {Δ}_{t}^{2} ,$$

combined with the Armjo step acceptance rule.

An advantage to such an approach with respect to certain prior approaches is that a formulation can be expressed at the continuous level and does not assume specific discretization schemes for the displacement and tensor fields. Moreover, such an approach can avoid explicitly extracting the rotational part of F(u), as well as the cost of performing SVDs. Such an approach can also help to simplify expressing the simulation adjoint, as will be discussed in more detail later herein.

After choosing a discrete basis for element spaces, computing the Newton step direction amounts to solving a linear system as given by:

$$[ \begin{matrix}A & & & {C}_{, u}^{T} \\ & {H}^{k} & & {C}_{S , T}^{k , T} \\ & & E & {C}_{, R}^{k , T} \\ C , u & {C}_{, S}^{k} & {C}_{, R}^{k} & \end{matrix} ] ( \begin{matrix}δ u \\ δ S \\ δ R \\ δσ\end{matrix} ) = ( \begin{matrix}b - {Au}^{k} - {C}_{, u}^{T} {σ}^{k} \\ - {ψ}^{k} - {C}_{, S}^{k , T} {σ}^{k} \\ - {C}_{, R}^{k , T} {σ}^{k} \\ - {c}^{k}\end{matrix} )$$

While the linear system will always have this general shape whatever our choice of discrete spaces, the latter will impact the sparsity pattern of the matrices and our options for solving it. It can be assumed that the basis functions (Nᵢ)_{K} over each mesh element K are Lagrange polynomials defined over a set of nodes (xᵢ)_{K}, leading to

$${N}_{i} ( {x}_{j} ) = {δ}_{j}^{i} .$$

For the displacement space V_{Ω} there should be H¹-compatible elements, i.e., continuity of the basis functions across neighboring elements. The choice may be restricted to usual P_{d} Lagrange elements, or so-called “serendipity” S_{d} elements, without internal nodes.

For the T_{Ω}, SO_{Ω}, Sym_{Ω} and Skew_{Ω} spaces, however, it is possible to only discretize L_{Ω}², so continuity across elements is not required and there can be increased flexibility. Numerical integration can be used to determine how to pick the nodes (xᵢ)_{K}. To integrate a function ƒ on element K, an approach according to at least one embodiment can use a discrete quadrature formula with weights ( ) and evaluation points (y), that is, on element we resort to a discrete quadrature formula with weights (wₚ)_{K} and evaluation points (yₚ)_{K}, as may be given by:

$${\int }_{K} f ∼ {\sum }_{p} {w}_{p} f ( {y}_{p} )$$

The weights and points can be selected such that the formula is exact for polynomials up to a given order. When evaluating the matrix A for a bilinear form defined from two sets of basis functions (Nᵢ)_{K} and (Nⱼ)_{K}, this can result in:

$${A}_{i , j} := {\int }_{K} {N}_{i} {N}_{j} f ∼ {\sum }_{p} {w}_{p} {N}_{i} ( {y}_{p} ) {N}_{j} ( {y}_{p} ) f ( {y}_{P} )$$

meaning that if the nodes and quadrature points are selected such that

$${( {x}_{i} )}_{K} = {( {x}_{k} )}_{K} = ( {y}_{p} ) ,$$

$$then {A}_{i , j} = {\sum }_{p} {w}_{p} {δ}_{i}^{j} f ( {y}_{p} ) ,$$

such that the matrix A becomes block diagonal. For a Lagrange polynomial basis of chosen degree d, the nodes (xᵢ)_{K} can be selected to correspond to the points of a quadrature formula that maximizes the order of accuracy for this number of points. In particular for quadrilateral or hexahedral elements, this can correspond to Gauss-Legendre points, which yield a quadrature formula that is exact for polynomials up to order 2d. For triangle and tetrahedral elements, quadratures of order 2d can be obtained for d≤1, while for higher degree polynomials numerical optimization may be relied upon.

By using such a choice of quadrature points to define the Lagrange nodes for the discrete subspaces T_{Ω}, SO_{Ω}, Sym_{Ω} and Skew_{Ω}, such an approach can render the matrices

$${H}^{k} , E , {C}_{S ,}^{k} and {C}_{R ,}^{k}$$

block-diagonal, while keeping a good order of accuracy for the numerical integration.

To finalize the Mixed FEM discretization, it remains to relate the displacement and tensor spaces. For hexahedral elements, serendipity elements of degree dS_{d} can be used for the displacement and tensor products of element-wise discontinuous Lagrange polynomials (with Gauss-Legendre nodes) of the same degree d for tensors. For tetrahedral elements, continuous Lagrange polynomials of degree dP_{d} can be used for the displacements, and discontinuous Lagrange polynomials of degree d−1 for the tensor spaces.

While it is possible to directly solve the linear system using a saddle-point solver, in practice it may be more efficient to perform double condensation. For the sake of clarity, this example will focus on the current Newton iteration and drop the k index for matrices and vectors.

In a first step, as H and E are block-diagonal and thus easily invertible, the unknowns S and R can be eliminated to obtain:

$$[ \begin{matrix}A & {C}_{, u}^{T} \\ C , u & - Λ\end{matrix} ] ( \begin{matrix}δ u \\ δσ\end{matrix} ) = ( \begin{matrix}b - Au - {C}_{, u}^{T} σ \\ λ\end{matrix} ) ,$$

$$Λ := {C}_{, S} {H}^{- 1} {C}_{, S}^{T} + {C}_{, R} {E}^{- 1} {C}_{, R}^{T} ,$$

$$λ := - c + {C}_{, S} {H}^{- 1} ( ψ + {C}_{, S}^{T} σ ) + {C}_{, R} {E}^{- 1} {C}_{, R}^{T} σ$$

It can be demonstrated that Λ is also block diagonal, and positive definite, as long as S is non-singular and ε>0. It can thus also be efficiently inverted, allowing to eliminate δσ and assemble the Schur complement system, as may be given by:

$$[ A + {C}_{u ,}^{T} {Λ}^{- 1} {C}_{u ,} ] ] δ u = b - Au + {C}_{u ,}^{T} {Λ}^{- 1} λ$$

This symmetric positive semi-definite system can be solved using, for example, a Jacobi-preconditioned Conjugate Gradient solver.

In at least one embodiment, it can be assumed that there is a set of simulation parameters p, and a loss function J(p,q) to be minimized, with q denoting the simulation end state, q:=(u, S, R, σ), and p denoting an optimizable vector of material and/or shape parameters. As q is the result of a forward simulation, q can depend in turn on the parameters p. To perform gradient-based optimization, a formula can be used as given by:

$$\frac{dJ}{dp} = \frac{\partial J}{\partial p} + \frac{\partial J}{\partial q} \frac{\partial q}{\partial p}$$

If focusing on a single simulation timestep, as for multiple timesteps, the adjoints can be chained together. By construction of a Newton solver in accordance with at least one embodiment, the simulation output q and the parameters p must satisfy the above requirements, in particular that they are the root of an implicit function which (for brevity of notation) can be written as we will write as f(p,q)=0. The implicit function theorem allows for expression of the adjoint as:

$$\frac{dJ}{dp} = \frac{\partial J}{\partial p} + \frac{\partial J}{\partial q} {( \frac{\partial f}{\partial q} )}^{- 1} \frac{\partial f}{\partial p}$$

$$As \frac{\partial f}{\partial q}$$

corresponds to the left-hand-side of a Newton iteration, computing

$$\frac{\partial J}{\partial q} {( \frac{\partial f}{\partial q} )}^{- 1}$$

amounts to solving one linear system similar to those of the forward pass. Then right-multiplication of the result by

$$\frac{\partial f}{\partial p}$$

can be performed by the adjoint code of the form assembly, which can be auto-generated in at least one embodiment.

While much of the discussion to this point has focused on unstructured meshes with full elements (i.e., where the mesh coincides with the material domain), generating high-quality conforming volumetric meshes from a surface is expensive, and not always differentiable. Accordingly, approaches in accordance with at least one embodiment can avoid building such a mesh altogether for the surfaces that are implicitly defined by SDF values on an hexahedral mesh, such as in marching cubes, OpenVDB, or FlexiCube grids.

For at least a mixed FEM simulation described above, it is not necessary to obtain the exact domain geometry. As discussed in more detail elsewhere herein, one approach only needs to be able to numerically integrate functions over elements with at least acceptable accuracy, where the level of accuracy needed or desired may be configurable. For a mesh element K and a domain Ω where K [symbol] Ω, the integrals can be performed over the part of K where there is material, i.e., K∩Ω. One first possibility, which will be referred to herein as the “Clip” quadrature (see FIG. 3B), would be to multiply the integrand, or equivalently the quadrature point weights, with the domain indicator function, as may be given by:

$${\int }_{K ⋂ Ω} f = {\int }_{K} {χ}_{Ω} ∼ {\sum }_{p} {w}_{p} {χ}_{Ω} ( {y}_{p} ) f ( {y}_{p} ) , {χ}_{Ω} := \{ \begin{matrix}1 on Ω \\ 0 elsewhere\end{matrix}$$

However, the indicator function χ_{Ω} is highly nonlinear and the quadrature quality may quickly degrade, leading to unstable simulations. Instead, one approach is to change the quadrature points and weights themselves in order for the new formula to accurately integrate polynomials on the actual material domain. This can involve looking for:

$${( {w}_{p}^{K} )}_{K} , {( {u}_{p}^{K} )}_{K}$$

$$such that$$

$${\int }_{K ⋂ Ω} f ∼ {\sum }_{p} {w}_{p}^{K} f ( {y}_{p}^{K} )$$

is accurate for polynomial functions ƒ up to a given degree d. Using an optimization point of view, this quest can be expressed as:

$${min}_{{w}_{p} , {y}_{p}} {Q}_{K} := ‖ {\int }_{K ⋂ Ω} f - {\sum }_{p} {w}_{p} f ( {y}_{p} ) , f ∈ ( {N}_{i}^{d} ) ‖$$

$$with ( {N}_{i}^{d} )$$

Lagrange polynomials of degree d.

In settings for at least one embodiment, the material domain Ω∩K can be defined as the portion of K where the SDF is negative, φ^{K}<0, with φ^{K} itself being defined from a finite set of values as

$${φ}^{K} ( x ) = {\sum }_{j} {φ}_{j}^{K} {N}_{j}^{φ} ,$$

and where the basis function N^{φ} is chosen to be similar for all elements (typically trilinear functions). This problem then reduces to finding, from a set of input SDF values

$$( {φ}_{j}^{K} ) ,$$

the quadrature points

$${( y )}_{p}^{K} ) and weights ( {w}_{p}^{K} )$$

that represent a solution to the minimization problem.

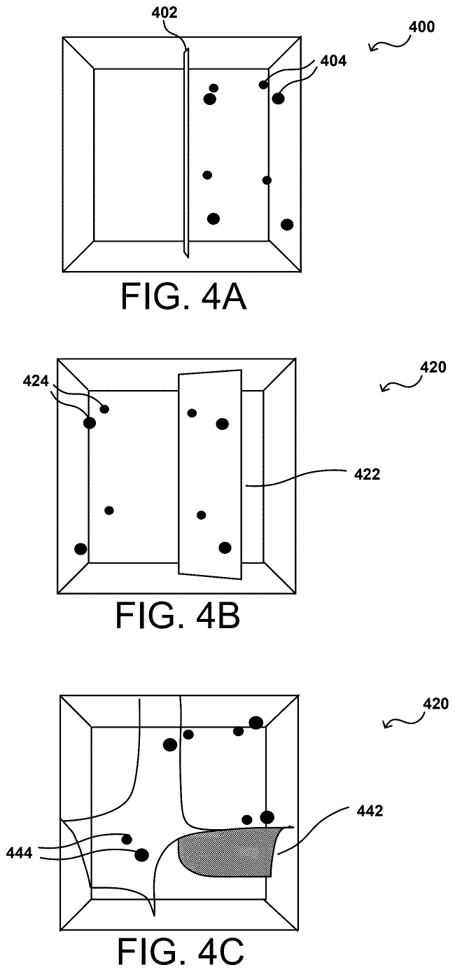

FIGS. 4A, 4B, and 4C illustrate example quadrature points that may be determined for different object surfaces in boundary cells, according to at least one embodiment. In these examples 400, 420, 440, there is a portion of an object surface 402, 422, 442 contained within a respective boundary cell. Here, the portions of the object surface have different locations, shapes, and/or properties. An MLP can attempt to determine appropriate and/or optimal quadrature points 404, 424, 444 for each such boundary cell, such that the quadrature points are located inside the object boundary (as determined from the signed distance values from the vertices). In at least one embodiment, these points can correspond to learned order-2 quadrature points that can be used to integrate over the part of the cell (or unit voxel) as defined using trilinear interpolation of the corner SDF values. In this example, the size is proportional to the quadrature point weight.

In at least one embodiment, a neural network can be used to infer appropriate quadrature points. In principle, one could optimize directly for an appropriate set of quadrature points, however this would need to be performed for every partially filled element of the mesh, likely at great cost. Moreover, the mapping (φⱼ) [symbol] (yₚ,wₚ) should be easily differentiable so that shape optimization can be performed. For at least these reasons, an approach in accordance with at least one embodiment can instead train a small neural network to learn the mapping. Such a network can be trained once and used for all experiments, although further training or refinement can be performed to improve accuracy over time if desired. In at least one embodiment, a network can be fit that takes as input a stacked vector of implicit SDF values at the corners of a cell, and outputs the quadrature point locations and weights within the cell. Network inputs can be normalized such that the gradient of φ is unit at the cell center, and network outputs are parameterized as offsets from the usual Gauss-Legendre points.

In at least one embodiment, the network architecture can be chosen to be a lightweight multilayer perceptron with N_{MLP}=5 fully-connected layers of size W_{MLP}=64, and ReLU activations on hidden layers. The loss function may then be defined as the sum:

$${ℒ}_{QuadNet} := {Q}_{k} + {10}^{2} {Q}_{+} + {10}^{1} {Q}_{□} + {10}^{- 3} {Q}_{★}$$

where [symbol] is given above, with target integrals ∫_{Ω∩K}ƒ computed using brute force uniform integration at high resolution, Q₊ is an L1 penalty enforcing the weights to be positive, [symbol] is a quadratic barrier enforcing quadrature coordinates to stay in [0, 1], and Q* is a conditioning term penalizing the log ratio of the maximum to minimum quadrature weight. A training set of 2²⁴ implicit function values can be randomly generated at cell corners, for example, training for 64k iterations with an AdamW (or other stochastic) optimizer with batch size 2²⁰. Training under such conditions was observed to take about six hours on an NVIDIA Geforce RTX 3080Ti GPU.

To perform Mixed FEM simulation on implicit shapes sampled to a grid, one approach is to replace the original regular Gauss-Legendre quadrature with the

$$( {y}_{p}^{K} , {w}_{p}^{K} )$$

inferred from this network. The basis function nodes for the discrete tensor spaces can similarly be displaced to the learned quadrature points

$$( {y}_{p}^{K} ) .$$

Combined with the simulation adjoint described above, such an approach can yield a fully differentiable pipeline from the corner SDF values φⱼ to the deformed object state q, allowing such an approach to handle many variants of material, shape, or topology optimization problems.

In one example implementation, a Mixed FEM solver was implemented using the warp.fem module from the NVIDIA Warp library, which allows such an approach to conveniently express the linear and bilinear forms, and provides auto-differentiated adjoint code for all of the domain and material parameters. One experiment consistent of sampling cylinder SDFs of varying aspect ratio on regular grids ranging from fine (64) to coarse (16) resolutions, and comparing the equilibrium shapes obtained using different numerical methods. The experiment generated either a tetrahedral mesh simulates with P₁/P_{0d} or P₂/P_{1d} elements, or a triangular surface-only mesh that was embedded in a sparse grid of regular hex elements and simulated using three quadrature formulas: a regular full-cell quadrature “Full”, a “Clip” quadrature where points are filtered according to the indicator function, and a “Neural” quadrature. The beams can be clamped at one end and equipped with a model, such as a Neohookcan constitutive model. As expected, the Full quadrature was observed to overestimate the material domain and thus the beam stiffness. At fine resolution, the tetrahedral discretization and both the Clip and Neural quadrature were observed to be in good agreement. However at coarse resolution, the P1/P_{0d} elements were observed to suffer from significant locking, while the Clip quadrature was observed to break down completely—due to not having enough quadrature points in the SDF interior—and collapse the beam. The neural quadrature still yielded coherent results.

In one example simulation, a slab of material was simulated that had heterogencities that were roughly the size of one voxel, so that the embedding grid is effectively dense (top left). Using the regular Full quadrature, the material behaves as if it were homogeneous, with globally uniform strain. The Clip quadrature also was observed to yield incorrect behavior, as the strain is no longer transmitted away from the dense clamped regions. The neural quadrature-based approach was observed to successfully capture the intricacies of the material at no additional cost.

As mentioned, a framework in accordance with at least one embodiment can allow for simulation of arbitrarily complex and evolving material topology, without the need for expensive remeshing. A natural application is a physics-ready virtual playground where a user (or application, etc.) may interactively add or subtract material and immediately observe how the topology responds to various applied forces.

In addition to a neural quadrature as disclosed herein being able to handle evolving material domains, such a quadrature can handle these domains in a differentiable way. This ability can be exploited to demonstrate physics-aware mesh reconstruction from dense views. In at least one embodiment, a FlexiCubes-based discrete implicit surface representation can be used. Such a representation can consist of SDF values and displacements at nodes of a regular grid, plus per-cell parameters adjusting the isosurface-effectively, per-cell, per-vertex SDF values with variable vertex positions. Such a representation has been demonstrated to perform well in conjunction with differentiable rasterization, with great ability at capturing sharp features. In at least one embodiment, a fully-coupled single stage pipeline can be used where gradients from a simulator directly affect reconstructed geometry.

In addition to terms for purely geometric reconstruction losses, which can be regroup concisely as [symbol] _{FC}, an additional physics-based loss function [symbol] _{phys} can be used that is based on the displacement (u) and stress (σ) fields resulting from the simulation over a timestep Δₜ, as may be given by:

$${ℒ}_{phys} ( {Δ}_{t} , {ℓ}_{u} , {ℓ}_{σ} ) := {\sqrt{{\int }_{Ω} \frac{1}{\vert det d Ω \vert} ( {ℓ}_{u} {‖ u ‖}^{p} + {ℓ}_{σ} {‖ σ ‖}^{p} )}}^{\frac{1}{p}}$$

where the

$$\frac{1}{\vert det d Ω \vert}$$

term scales the local loss inversely to the infinitesimal domain measure to prevent the empty domain from being a trivial optimum, [symbol] ᵤ and [symbol] _{σ} are constant scaling factors for the displacement and stress terms, and the loss power p allows for skewing of the global loss towards either the average or the maximum local loss, such as by using p=8 in at least some embodiments. It was observed that the [symbol] _{FC} and [symbol] _{phys} losses both affect the shape of the reconstructed model and will oppose each other. Tuning the [symbol] ᵤ and [symbol] _{σ} coefficients allow biasing the result towards better reconstruction fidelity or physical performance. Moreover, activating [symbol] _{phys} right from the beginning of the optimization may not be particularly productive. When starting with random SDF values, which may lead to many disconnected material pieces, running the physical simulation at such an early stage may not be meaningful. Instead, a first portion (e.g., the first 30%) of the optimizer iterations can be run with [symbol] _{FC} only, then adding [symbol] _{phys}. To ensure a smooth transition, the timestep δ can also be increased progressively.

However, performing gradient descent on [symbol] _{phys} tends to produce “bumpy” or fractured surfaces that, while yielding low values of the physics loss, are not visually pleasing. This issue can be overcome, at least in part, by preconditioning the grid parameters that are being optimized for (vertex displacement and SDF value) with a smoothing function. In practice, a convolution with a Gaussian blur kernel can be applied before passing those parameters to the FlexiCubes reconstruction and Mixed FEM simulation. In a similar fashion, symmetry of the optimized shape can optionally be enforced by applying a symmetric preconditioner to the raw grid parameters. Adding a loss term [symbol] _{|e|} penalizing the total sum of edge lengths of the extracted triangular mesh is helpful for reducing the appearance of unwanted geometry like floaters or protruding details—under the condition that this term remains small compared to the reconstruction and physics losses.

In an example relating to stress optimization, an approach according to at least one embodiment can be applied to optimize the topology of an object, such as an aluminum hook, so that stress under some predefined load is minimized. In one example, this can use [symbol] _{phys} with [symbol] ᵤ=0 and [symbol] _{σ}=1. A Neo-Hookean material can be used with Young Modulus E=10 Gpa, Poisson ratio ν=0.33, and volumetric mass ρ=2700 kg·m⁻³, and a FlexiCube grid with resolution 64. A force of 6 kN can be applied to the curved part while keeping the hook fixed near the opening. Over the course of the optimization, the physics loss [symbol] _{phys} is reduced by more than an order of magnitude, with the maximum stress on the surface also dropping by a factor of 10.

Such an approach can also be evaluated using more challenging material topology and nonlinear effects, such as may relate to deformable or manipulable chairs. In one example experiment, 18 representative chair models were selected and equipped with a rubber-like material, with volumetric mass ρ=1000 kg·m⁻³, Young modulus E=10 MPa and Poisson ratio ν=0.47. Emulating the effect of one person sitting on the chair, a downward force of 2.5 kN was applied on the seat, with a backward force of 0.5 kN applied on the backrest, with a random perturbation of 15% of the force direction and center at each iteration. Since it may not be known in advance where the material will exist, those forces can be defined in a volumetric fashion over a predefined region of the reconstruction bounding box, and scaled according to the actual amount of material in the region. The bottom 5% of each object can be kept fixed. One example experiment used a timestep Δₜ=3 s, loss scaling parameters [symbol] ᵤ=1 and [symbol] _{σ}=0.25, and a FlexiCube resolution of 64. The optimization was run for 1000 gradient descent iterations, and for each of those 5 Newton steps of Mixed FEM quasistatic simulation were run, which in total takes about 15 to 25 minutes per model depending on the number of active voxels. While applying the forces to the chairs reconstructed without the physics-aware loss usually leads to a complete collapse, the chairs reconstructed with [symbol] _{phys} demonstrate much stronger resistance and are easily able to recover their original shape once the perturbations cease being applied. The optimization generally reinforces the chair legs and the seat-backrest junction, but with variations depending on the actual topology, such as the presence (or lack of presence) of armrests.

In some prior experiments, the bottom portions of the chairs were kept fixed, which may be justifiable given the strong downward applied force. An approach in accordance with at least one embodiment can also help improve the toppling stability of the reconstructed models. This can be accomplished in part by replacing the bilateral clamping with an unilateral constraint modeling the ground-chair contact, and updating the Newton loop with an active set formulation. A “stiffer” material can be used so that a given chair behaves rigidly (E=1 Gpa), applying a downward-and-backward-pointing force on the backrest, and picking a model that looks propitious to toppling. It was observed that, as expected, the physics-aware loss will add material to the front of the chair such that the center of mass moves forward.

In some approaches, an optimizer may only have been allowed to modify the shape of the model, keeping the material homogeneous. Approaches in accordance with at least one embodiment can also allow for modification of the Young Modulus. Such modification can help to simplify the problem, as now the physics loss and reconstruction loss can act on orthogonal parameters. In an example framework according to at least one embodiment, parameters [symbol] ᵤ and [symbol] _{σ} can be set to small values so that the optimizer will favor [symbol] _{FC} or [symbol] _{phys} for the shape parameters. The legs of the chair and the junction between legs and seat are the regions that the optimizer prioritized for stiffening in one example.

A physics-aware shape reconstruction formulation as disclosed herein is not limited to geometric reconstruction losses, as shown above. Such a simulator can also be paired with a differentiable renderer, which allows for the reconstruction of structurally reinforced geometry from multi-view images. In at least one embodiment, a photogrammetry pipeline such as NVDIFFREC from NVIDIA Corporation can be leveraged that jointly optimizes shape, materials, and lighting from image supervision. NVDIFFREC supports FlexiCubes as its geometry representation. Similar to a setup discussed previously, the rendering loss L_{render} can first be optimized from the NVDIFFREC pipeline without modification. After the shape converges, the process can begin to blend in the physics loss function L_{phys}.

Additional variations can be implemented as well in various embodiments. For example, new degrees of freedom can be added to disconnected voxel configurations. Additionally, while evaluation of integrals over the boundary of the domain may not be considered in at least some embodiments, as these may not be needed for at least certain tasks, meshes such as isosurface meshes could be extracted and embedded for integration in at least one embodiment.

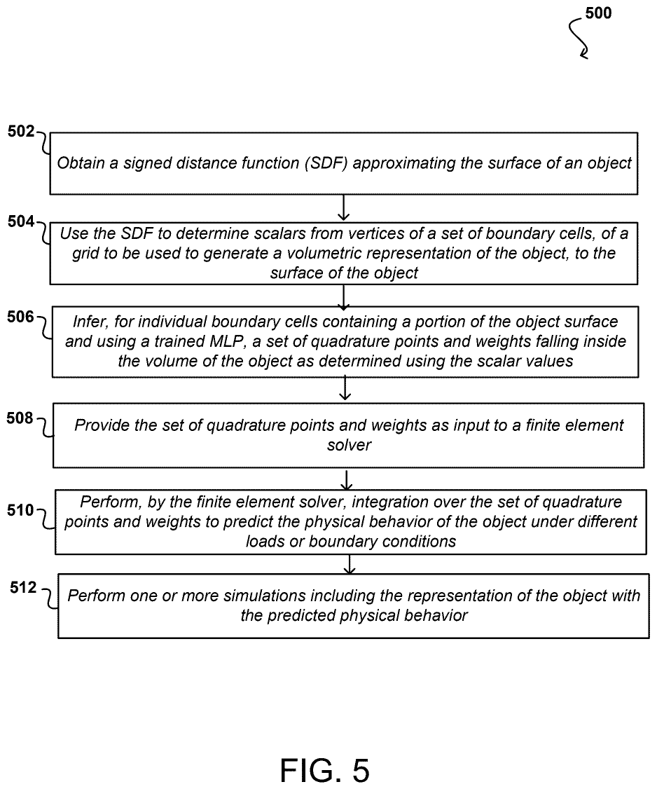

FIG. 5 illustrates an example process 500 that can be performed to simulate deformable objects using implicit functions, according to at least one embodiment. It should be understood that for these and other processes presented herein there may be additional, fewer, or alternative steps performed in similar or alternative orders, or at least partially in parallel, within the scope of the various embodiments unless otherwise specifically stated. Further, although this example will be discussed with respect to SDFs, MLPs, and simulations, there can be other types of functions and models used to determine appropriate quadrature points for integration or other such purposes, as may be useful for tasks or operations other than performing simulations as discussed and suggested elsewhere herein. In this example process 500, a signed distance function (SDF) is obtained 502 (or generated, etc.) that approximates the surface of an object. The object can have a representation generated with respect to a regular grid of cells. The SDF can be used 504 to determine scalars from the vertices of the cells to a surface of the object. This can include, for boundary cells that include a portion of the object surface, one or more scalars having a positive magnitude and one or more scalars having a negative magnitude, corresponding to portions of the cell that are outside, and inside, the object volume, respectively. Interpolation can be performed with respect to these scalars to generate an approximation of the shape and location of the surface in those boundary cells. A trained MLP (or other such machine learning model) can be used to infer 506, for those individual boundary cells, a set of quadrature points (with corresponding weights) falling inside the object volume, based in part on the interpolated or approximated object surface. The set of quadrature points and weights can be provided 508 as input to a finite element solver (or other such module or process). The finite element solver can perform 510 integration over the set of quadrature points (and weights) to predict the physical behavior of the object under different loads, boundary conditions, or other such variations. One or more simulations can then be performed 512 using the presentation of the object with the predicted physical behavior. For example, a series of different applications of force, with different magnitudes, directions, and/or locations, can be simulated to determine the response of the object. One or more behavioral aspects of the object representation can be modified if appropriate to model the desired physical behavior of the object. Such a neural integration process can provide high quality results for voxel-based, implicit volume simulations (or other such simulations) at little-to-no additional runtime cost. Such a process can take advantage of a solver, such as a mixed FEM solver, to efficiently perform elasticity simulation on deformable and/or continuously evolving domains. Such an approach can provide for straightforward differentiation of the simulation results with respect to the implicit volume parameters, making such an approach particularly suitable for topology optimization tasks, and allowing for robust physics-enabled shape reconstruction. In at least one embodiment, a finite element method (FEM) solver can be used in both continuous and discrete settings to serve as a basis for differentiable elasticity simulations.

In at least one embodiment, the desired physical behavior may not be known up front. For example, an engineer might want to design the strongest bracket that falls within a set of size and/or shape parameters, but that also weighs as little as possible. A simulation mechanism as presented herein allows for performance of such structural optimization tasks. Such a simulation environment can also be used to attempt to determine realistic physical behavior of objects for which image or video data was captured in a physical environment, where a physically-accurate digital reconstruction is to be generated. Various simulations can be performed that apply different forces in different ways to see how the object deforms or reacts. Such an approach can provide for efficient computation and simulation of deformable objects with physically accurate behavior.

Aspects of various approaches presented herein can be lightweight enough to execute in various locations, such as on a client device or cloud server, in near real time. Such processing can be performed on, or for, content that is generated on, or received by, a client device or server, or received from an external source, such as content received over at least one network from a cloud server 620 or third party service 660, among other such options. In some instances, at least a portion of the processing, generation, compositing, and/or determination of this content may be performed by one of these other devices, systems, or entities, then provided to the client device 602 (or another such recipient) for presentation or another such use.

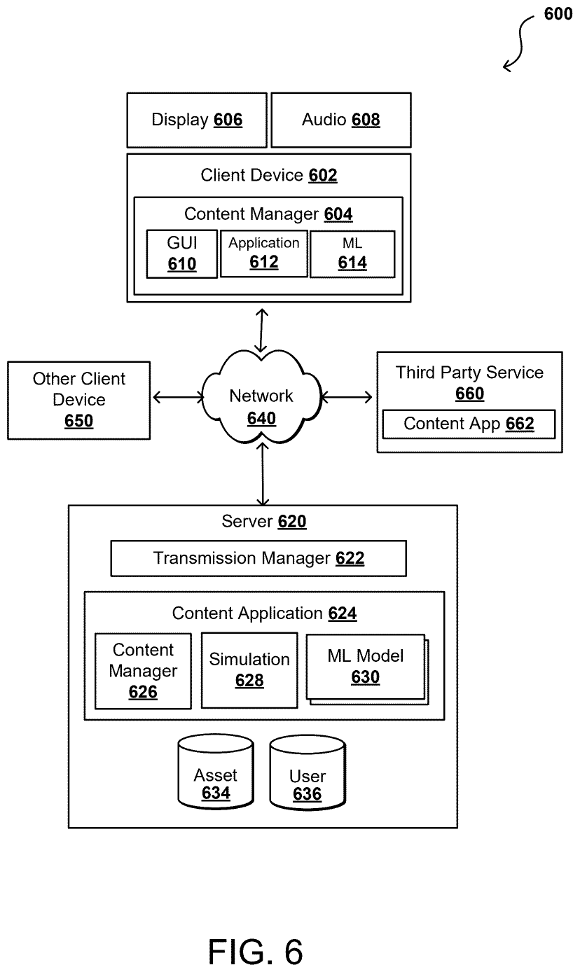

As an example, FIG. 6 illustrates an example network configuration 600 that can be used to provide, generate, modify, encode, process, and/or transmit various types of data or content. In at least one embodiment, a client device 602 can generate or receive data for a session using components of a content manager 604 and/or content application 612 on client device 602 and data stored locally on that client device. In at least one embodiment, a content application 624 executing on a server 620 (e.g., a cloud server or edge server) may initiate a session associated with at least one client device 602, as may utilize a session manager and user data stored in a user database 636, and can cause content such as one or more digital assets (e.g., implicit and/or explicit object representations) from an asset repository 634 to be determined by a content manager 626. A content manager 626 may work with at least simulation environment 628 to perform simulation using one or more object representations as defined by the assets either explicitly or implicitly. For implicit representations, such as those corresponding to signed distance functions, one or more one machine learning models 630 may be used to determine optimal quadrature points to use for the simulation, such as may be used with finite element analysis. In at least one embodiment, the content application 624 can work with one or more encoders, transcoders, and/or compressors that can perform tasks such as encoding, decoding, compression, and/or decompression of a texture, image, or other such asset or instance of content, where different compressions or encodings may be beneficial for different operations, such as for storage versus processing. At least a portion of the content (e.g., simulation data) may be transmitted to the client device 602 using an appropriate transmission manager 622 to send by download, streaming, or another such transmission channel. An encoder may be used to encode and/or compress at least some of this data before transmitting to the client device 602. In at least one embodiment, the client device 602 receiving such content can provide this content to a corresponding content application 604, which may also or alternatively include a graphical user interface 610, content application 612, and machine learning model 614 for use in inferencing, providing, synthesizing, rendering, compositing, modifying, or using content for presentation (or other purposes) on or by the client device 602. A decoder may also be used to decode data received over the network(s) 640 for presentation via client device 602, such as image or video content through a display 606 and audio, such as sounds and music, through at least one audio playback device 608, such as speakers or headphones. In at least one embodiment, at least some of this content may already be stored on, rendered on, or accessible to client device 602 such that transmission over network 640 is not required for at least that portion of content, such as where that content may have been previously downloaded or stored locally on a hard drive or optical disk. In at least one embodiment, a transmission mechanism such as data streaming can be used to transfer this content from server 620, or user database 636, to client device 602. In at least one embodiment, at least a portion of this content can be obtained, enhanced, and/or streamed from another source, such as a third party service 660 or other client device 650, that may also include a content application 662 for generating, enhancing, or providing content. In at least one embodiment, portions of this functionality can be performed using multiple computing devices, or multiple processors within one or more computing devices, such as may include a combination of CPUs and GPUs.

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server that sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device, or may incorporate one or more Virtual Machines (VMs). In at least one embodiment, such a system can be implemented at least partially in a data center or at least partially using cloud computing resources.

### Inference and Training Logic

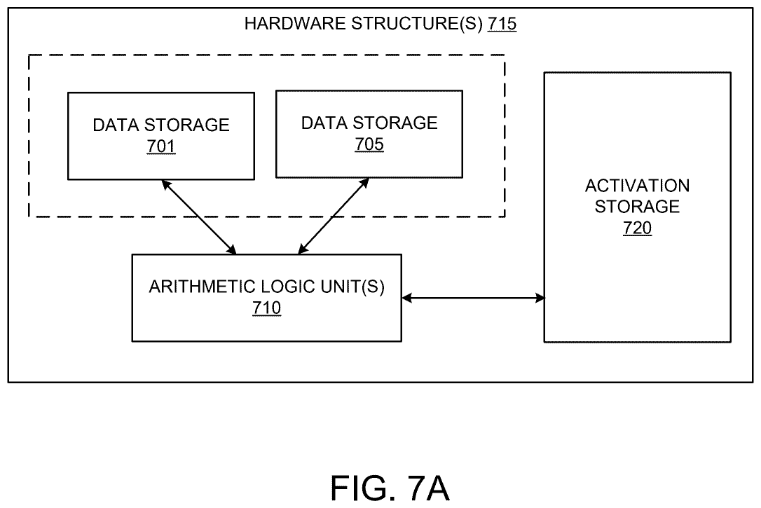

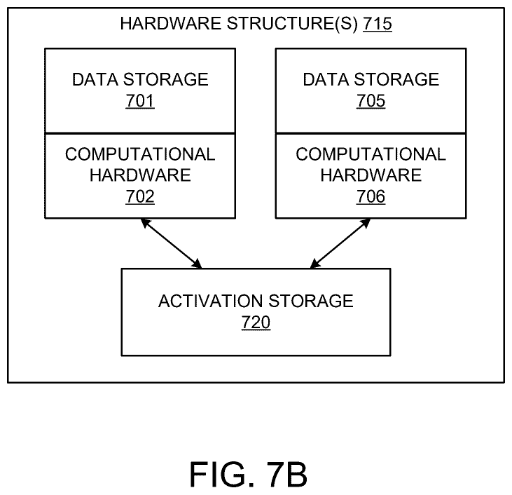

FIG. 7A illustrates inference and/or training logic 715 used to perform inferencing and/or training operations associated with one or more embodiments. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or data storage 701 may be cache memory, dynamic randomly addressable memory (“DRAM”), static randomly addressable memory (“SRAM”), non-volatile memory (e.g., Flash memory), or other storage. In at least one embodiment, choice of whether code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to on one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or code and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Data Center

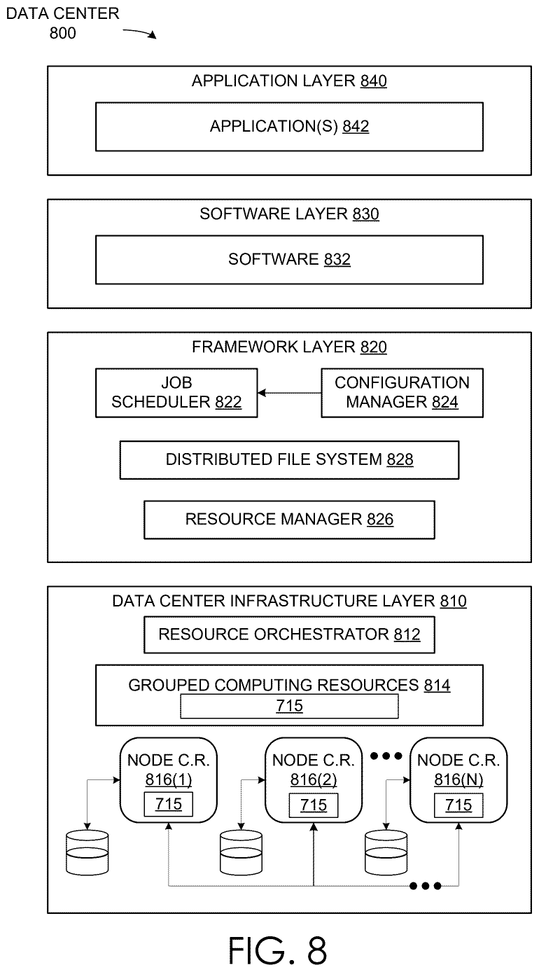

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 812 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underused and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used to simulate differentiable and elastic objects using implicit functions, where one or more neural networks can be used to determine appropriate quadrature points for the simulation.

### Computer Systems

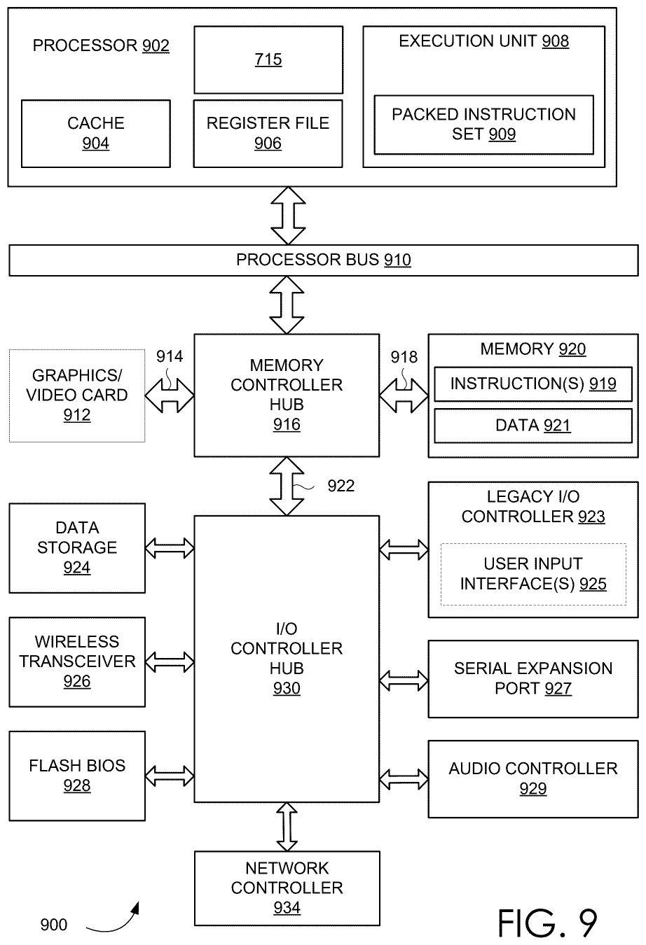

FIG. 9 is a block diagram illustrating an exemplary computer system, which may be a system with interconnected devices and components, a system-on-a-chip (SOC) or some combination thereof 900 formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computing (“CISC”) microprocessor, a reduced instruction set computing (“RISC”) microprocessor, a very long instruction word (“VLIW”) computing microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used to simulate differentiable and elastic objects using implicit functions, where one or more neural networks can be used to determine appropriate quadrature points for the simulation.

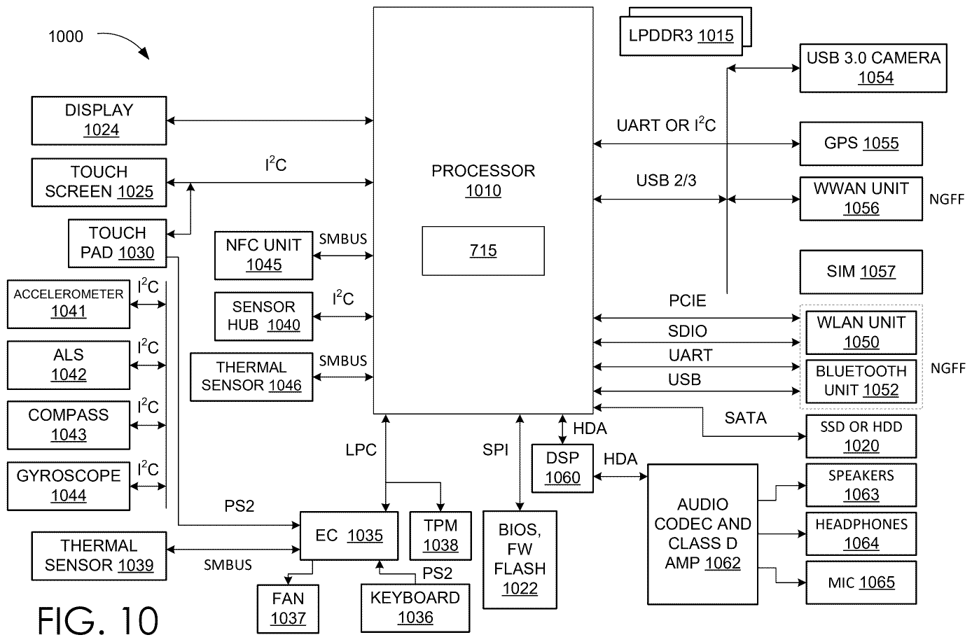

FIG. 10 is a block diagram illustrating an electronic device 1000 for utilizing a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speakers 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 10 for inferencing or predicting operations based, at least in part, on weight parameters calculated using neural network training operations, neural network functions and/or architectures, or neural network use cases described herein.

Such components can be used to simulate differentiable and elastic objects using implicit functions, where one or more neural networks can be used to determine appropriate quadrature points for the simulation.

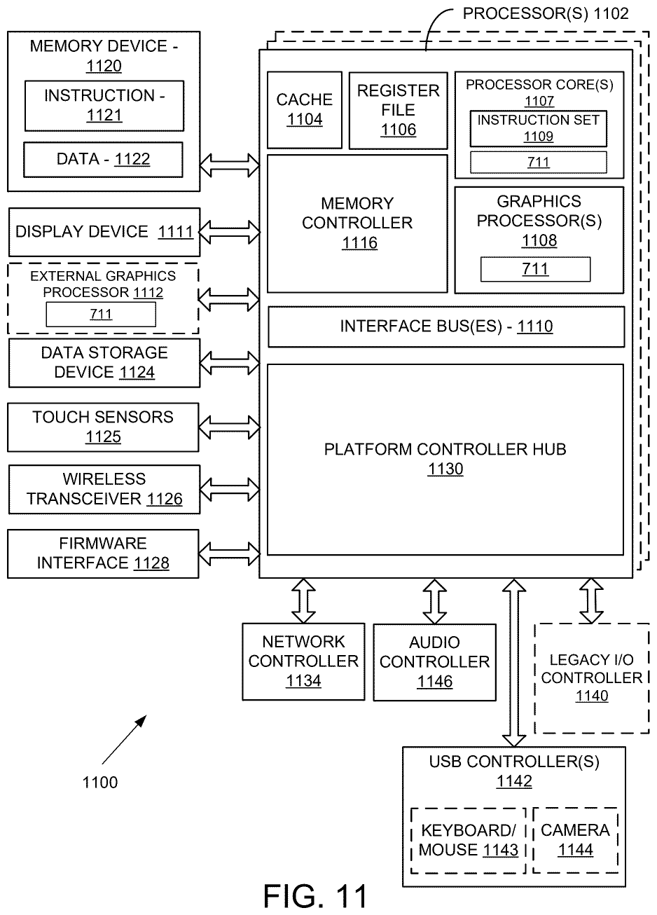

FIG. 11 is a block diagram of a processing system, according to at least one embodiment. In at least one embodiment, system 1100 includes one or more processor(s) 1102 and one or more graphics processor(s) 1108, and may be a single processor desktop system, a multiprocessor workstation system, or a server system having a large number of processor(s) 1102 or processor core(s) 1107. In at least one embodiment, system 1100 is a processing platform incorporated within a system-on-a-chip (SoC) integrated circuit for use in mobile, handheld, or embedded devices.

In at least one embodiment, system 1100 can include, or be incorporated within a server-based gaming platform, a game console, including a game and media console, a mobile gaming console, a handheld game console, or an online game console. In at least one embodiment, system 1100 is a mobile phone, smart phone, tablet computing device or mobile Internet device. In at least one embodiment, processing system 1100 can also include, coupled with, or be integrated within a wearable device, such as a smart watch wearable device, smart eyewear device, augmented reality device, or virtual reality device. In at least one embodiment, processing system 1100 is a television or set top box device having one or more processor(s) 1102 and a graphical interface generated by one or more graphics processor(s) 1108.

In at least one embodiment, one or more processor(s) 1102 each include one or more processor core(s) 1107 to process instructions which, when executed, perform operations for system and user software. In at least one embodiment, each of one or more processor core(s) 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor core(s) 1107 may each process a different instruction set 1109, which may include instructions to facilitate emulation of other instruction sets. In at least one embodiment, processor core(s) 1107 may also include other processing devices, such a Digital Signal Processor (DSP).

In at least one embodiment, processor(s) 1102 includes cache memory 1104. In at least one embodiment, processor(s) 1102 can have a single internal cache or multiple levels of internal cache. In at least one embodiment, cache memory is shared among various components of processor(s) 1102. In at least one embodiment, processor(s) 1102 also uses an external cache (e.g., a Level-3 (L3) cache or Last Level Cache (LLC)) (not shown), which may be shared among processor core(s) 1107 using known cache coherency techniques. In at least one embodiment, register file 1106 is additionally included in processor(s) 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor(s) 1102 and other components in system 1100. In at least one embodiment, interface bus(es) 1110, in one embodiment, can be a processor bus, such as a version of a Direct Media Interface (DMI) bus. In at least one embodiment, interface bus(es) 1110 is not limited to a DMI bus, and may include one or more Peripheral Component Interconnect buses (e.g., PCI, PCI Express), memory busses, or other types of interface busses. In at least one embodiment processor(s) 1102 include an integrated memory controller 1116 and a platform controller hub 1130. In at least one embodiment, memory controller 1116 facilitates communication between a memory device and other components of system 1100, while platform controller hub (PCH) 1130 provides connections to I/O devices via a local I/O bus.

In at least one embodiment, memory device 1120 can be a dynamic random access memory (DRAM) device, a static random access memory (SRAM) device, flash memory device, phase-change memory device, or some other memory device having suitable performance to serve as process memory. In at least one embodiment memory device 1120 can operate as system memory for system 1100, to store data 1122 and instruction 1121 for use when one or more processor(s) 1102 executes an application or process. In at least one embodiment, memory controller 1116 also couples with an optional external graphics processor 1112, which may communicate with one or more graphics processor(s) 1108 in processor(s) 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (e.g., DisplayPort, etc.). In at least one embodiment, display device 1111 can include a head mounted display (HMD) such as a stereoscopic display device for use in virtual reality (VR) applications or augmented reality (AR) applications.

In at least one embodiment, platform controller hub 1130 enables peripherals to connect to memory device 1120 and processor(s) 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 can connect via a storage interface (e.g., SATA) or via a peripheral bus, such as a Peripheral Component Interconnect bus (e.g., PCI, PCI Express). In at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as a 3G, 4G, or Long Term Evolution (LTE) transceiver. In at least one embodiment, firmware interface 1128 enables communication with system firmware, and can be, for example, a unified extensible firmware interface (UEFI). In at least one embodiment, network controller 1134 can enable a network connection to a wired network. In at least one embodiment, a high-performance network controller (not shown) couples with interface bus(es) 1110. In at least one embodiment, audio controller 1146 is a multi-channel high definition audio controller. In at least one embodiment, system 1100 includes an optional legacy I/O controller 1140 for coupling legacy (e.g., Personal System 2 (PS/2)) devices to system. In at least one embodiment, platform controller hub 1130 can also connect to one or more Universal Serial Bus (USB) controller(s) 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, system 1100 can include an external memory controller 1116 and platform controller hub 1130, which may be configured as a memory controller hub and peripheral controller hub within a system chipset that is in communication with processor(s) 1102.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into graphics processor 1500. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used to simulate differentiable and elastic objects using implicit functions, where one or more neural networks can be used to determine appropriate quadrature points for the simulation.

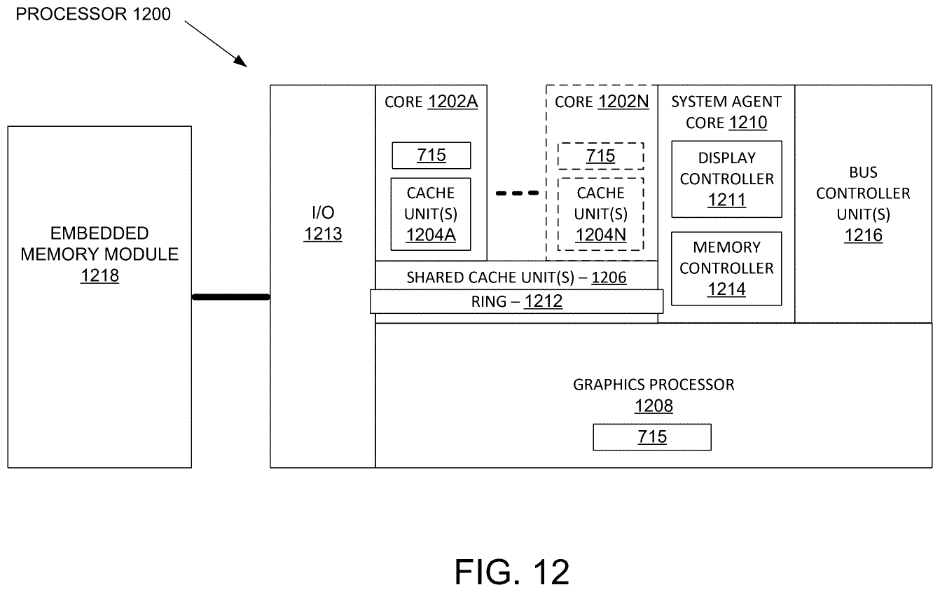

FIG. 12 is a block diagram of a processor 1200 having one or more processor core(s) 1202A-1202N, an integrated memory controller 1214, and an integrated graphics processor 1208, according to at least one embodiment. In at least one embodiment, processor 1200 can include additional cores up to and including additional core 1202N represented by dashed lined boxes. In at least one embodiment, each of processor core(s) 1202A-1202N includes one or more internal cache unit(s) 1204A-1204N. In at least one embodiment, each processor core also has access to one or more shared cached unit(s) 1206.

In at least one embodiment, internal cache unit(s) 1204A-1204N and shared cache unit(s) 1206 represent a cache memory hierarchy within processor 1200. In at least one embodiment, cache unit(s) 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache unit(s) 1206 and 1204A-1204N.

In at least one embodiment, processor 1200 may also include a set of one or more bus controller unit(s) 1216 and a system agent core 1210. In at least one embodiment, one or more bus controller unit(s) 1216 manage a set of peripheral buses, such as one or more PCI or PCI express busses. In at least one embodiment, system agent core 1210 provides management functionality for various processor components. In at least one embodiment, system agent core 1210 includes one or more integrated memory controllers 1214 to manage access to various external memory devices (not shown).

In at least one embodiment, one or more of processor core(s) 1202A-1202N include support for simultaneous multi-threading. In at least one embodiment, system agent core 1210 includes components for coordinating and processor core(s) 1202A-1202N during multi-threaded processing. In at least one embodiment, system agent core 1210 may additionally include a power control unit (PCU), which includes logic and components to regulate one or more power states of processor core(s) 1202A-1202N and graphics processor 1208.

In at least one embodiment, processor 1200 additionally includes graphics processor 1208 to execute graphics processing operations. In at least one embodiment, graphics processor 1208 couples with shared cache unit(s) 1206, and system agent core 1210, including one or more integrated memory controllers 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with a ring based interconnect unit 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor core(s) 1202A-1202N and graphics processor 1208 use embedded memory modules 1218 as a shared Last Level Cache.

In at least one embodiment, processor core(s) 1202A-1202N are homogenous cores executing a common instruction set architecture. In at least one embodiment, processor core(s) 1202A-1202N are heterogeneous in terms of instruction set architecture (ISA), where one or more of processor core(s) 1202A-1202N execute a common instruction set, while one or more other cores of processor core(s) 1202A-1202N executes a subset of a common instruction set or a different instruction set. In at least one embodiment, processor core(s) 1202A-1202N are heterogeneous in terms of microarchitecture, where one or more cores having a relatively higher power consumption couple with one or more power cores having a lower power consumption. In at least one embodiment, processor 1200 can be implemented on one or more chips or as an SoC integrated circuit.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processor 1200. For example, in at least one embodiment, training and/or inferencing techniques described herein may use one or more of ALUs embodied in graphics processor 1208, graphics core(s) 1202A-1202N, or other components in FIG. 12. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of graphics processor 1200 to perform one or more machine learning algorithms, neural network architectures, use cases, or training techniques described herein.

Such components can be used to simulate differentiable and elastic objects using implicit functions, where one or more neural networks can be used to determine appropriate quadrature points for the simulation.

### Virtualized Computing Platform

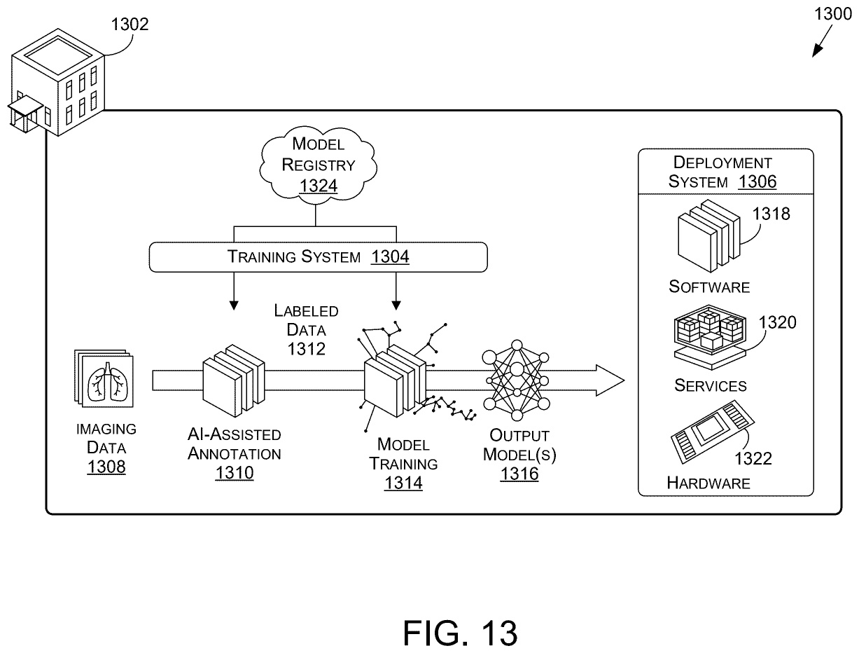

FIG. 13 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facilities 1302. Process 1300 may be executed within a training system 1304 and/or a deployment system 1306. In at least one embodiment, training system 1304 may be used to perform training, deployment, and implementation of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility 1302. In at least one embodiment, one or more applications in a pipeline may use or call upon services (e.g., inference, visualization, compute, AI, etc.) of deployment system 1306 during execution of applications.

In at least one embodiment, some of applications used in advanced processing and inferencing pipelines may use machine learning models or other AI to perform one or more processing steps. In at least one embodiment, machine learning models may be trained at facility 1302 using data 1308 (such as imaging data) generated at facility 1302 (and stored on one or more picture archiving and communication system (PACS) servers at facility 1302), may be trained using imaging or sequencing data 1308 from another facility(ies), or a combination thereof. In at least one embodiment, training system 1304 may be used to provide applications, services, and/or other resources for generating working, deployable machine learning models for deployment system 1306.

In at least one embodiment, model registry 1324 may be backed by object storage that may support versioning and object metadata. In at least one embodiment, object storage may be accessible through, for example, a cloud storage compatible application programming interface (API) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training system 1304 (FIG. 13) may include a scenario where facility 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of imaging data 1308 (e.g., from certain devices). In at least one embodiment, AI-assisted annotation 1310 may then be used directly, or may be adjusted or fine-tuned using an annotation tool to generate ground truth data. In at least one embodiment, AI-assisted annotation 1310, labeled data 1312, or a combination thereof may be used as ground truth data for training a machine learning model. In at least one embodiment, a trained machine learning model may be referred to as output model(s) 1316, and may be used by deployment system 1306, as described herein.

In at least one embodiment, a training pipeline may include a scenario where facility 1302 needs a machine learning model for use in performing one or more processing tasks for one or more applications in deployment system 1306, but facility 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility 1302 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model(s) 1316—and may be used in deployment system 1306 to perform one or more processing tasks for one or more applications of a deployment system.

In at least one embodiment, a scenario may include facility 1302 requiring a machine learning model for use in performing one or more processing tasks for one or more applications in deployment system 1306, but facility 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314—e.g., AI-assisted annotation 1310, labeled data 1312, or a combination thereof—may be used as ground truth data for retraining or updating a machine learning model. In at least one embodiment, a trained machine learning model may be referred to as output model(s) 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility 1302 after processing through a pipeline (e.g., to convert outputs back to a usable data type). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (e.g., imaging data 1308) in a specific format in response to an inference request (e.g., a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 1316 of training system 1304.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., system 1200 of FIG. 12). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by system 1300 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1300 of FIG. 13). In at least one embodiment, completed and validated applications or containers may be stored in a container registry and associated machine learning models may be stored in model registry 1324. In at least one embodiment, a requesting entity—who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306 (e.g., a cloud) to perform processing of data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1320 may be leveraged. In at least one embodiment, services 1320 may include compute services, artificial intelligence (AI) services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel (e.g., using a parallel computing platform 1230 (FIG. 12)). In at least one embodiment, rather than each application that shares a same functionality offered by services 1320 being required to have a respective instance of services 1320, services 1320 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects-such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where services 1320 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, graphics cards, an AI/deep learning system (e.g., an AI supercomputer, such as NVIDIA's DGX), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility 1302), within an AI/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (e.g., hardware and software combination of NVIDIA's DGX System). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

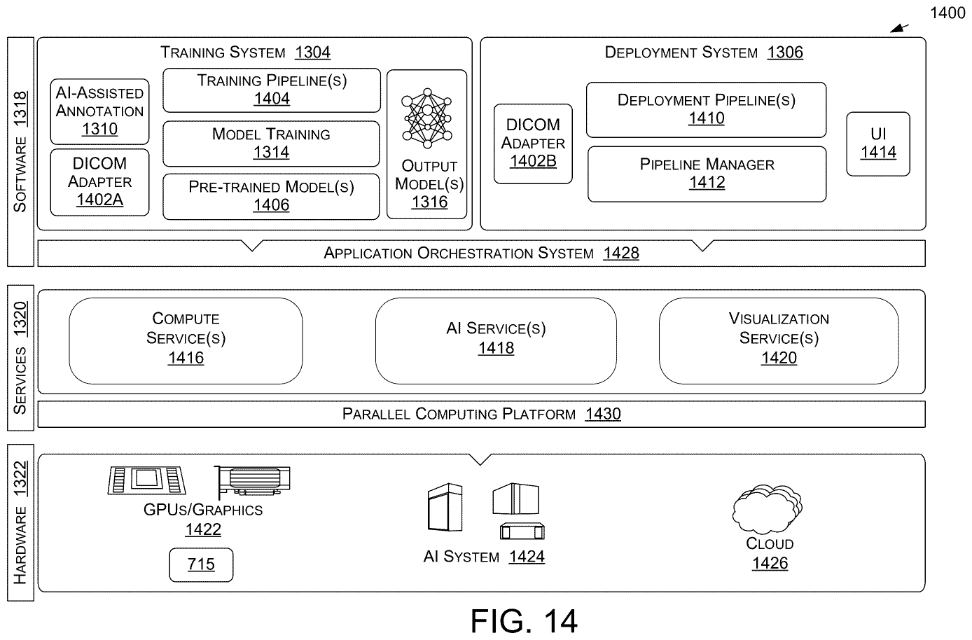

FIG. 14 is a system diagram for an example system 1400 for generating and deploying an imaging deployment pipeline, in accordance with at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1304 may execute training pipelines 1404, similar to those described herein with respect to FIG. 13. In at least one embodiment, where one or more machine learning models are to be used in deployment pipeline(s) 1410 by deployment system 1306, training pipelines 1404 may be used to train or retrain one or more (e.g. pre-trained) models, and/or implement one or more of pre-trained models 1406 (e.g., without a need for retraining or updating). In at least one embodiment, as a result of training pipelines 1404, output model(s) 1316 may be generated. In at least one embodiment, training pipelines 1404 may include any number of processing steps, such as but not limited to imaging data (or other input data) conversion or adaption In at least one embodiment, for different machine learning models used by deployment system 1306, different training pipelines 1404 may be used. In at least one embodiment, training pipeline 1404 similar to a first example described with respect to FIG. 13 may be used for a first machine learning model, training pipeline 1404 similar to a second example described with respect to FIG. 13 may be used for a second machine learning model, and training pipeline 1404 similar to a third example described with respect to FIG. 13 may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1316 and/or pre-trained models 1406 may include any types of machine learning models depending on implementation or embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, training pipelines 1404 may include AI-assisted annotation, as described in more detail herein with respect to at least FIG. 14. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation may be performed as part of deployment pipeline(s) 1410; either in addition to, or in lieu of AI-assisted annotation included in training pipelines 1404. In at least one embodiment, system 1400 may include a multi-layer platform that may include a software layer (e.g., software 1318) of diagnostic applications (or other application types) that may perform one or more medical imaging and diagnostic functions. In at least one embodiment, system 1400 may be communicatively coupled to (e.g., via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1302). In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner. In at least one embodiment, communications sent to, or received by, a training system 1304 and a deployment system 1306 may occur using a pair of DICOM adapters 1402A, 1402B.

In at least one embodiment, deployment system 1306 may execute deployment pipeline(s) 1410. In at least one embodiment, deployment pipeline(s) 1410 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline(s) 1410 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline(s) 1410 depending on information desired from data generated by a device. In at least one embodiment, where detections of anomalies are desired from an MRI machine, there may be a first deployment pipeline(s) 1410, and where image enhancement is desired from output of an MRI machine, there may be a second deployment pipeline(s) 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1400—such as services 1320 and hardware 1322—deployment pipeline(s) 1410 may be even more user friendly, provide for easier integration, and produce more accurate, efficient, and timely results.

In at least one embodiment, deployment system 1306 may include a user interface (“UI”) 1414 (e.g., a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, UI 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to services 1320, and/or from application or service to hardware 1322. In at least one embodiment, although illustrated as included in software 1318, this is not intended to be limiting, and in some examples pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1320 leveraged by and shared by applications or containers in deployment system 1306 may include compute service(s) 1416, AI service(s) 1418, visualization service(s) 1420, and/or other service types. In at least one embodiment, applications may call (e.g., execute) one or more of services 1320 to perform processing operations for an application. In at least one embodiment, compute service(s) 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA) may enable general purpose computing on GPUs (GPGPU) (e.g., GPUs/Graphics 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1418 may be leveraged to perform inferencing services for executing machine learning model(s) associated with applications (e.g., tasked with performing one or more processing tasks of an application). In at least one embodiment, AI service(s) 1418 may leverage AI system 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output model(s) 1316 from training system 1304 and/or other models of applications to perform inference on imaging data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI service(s) 1418.

In at least one embodiment, shared storage may be mounted to AI service(s) 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<10 min). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provide through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization service(s) 1420 may be leveraged to generate visualizations for viewing outputs of applications and/or deployment pipeline(s) 1410. In at least one embodiment, GPUs/Graphics 1422 may be leveraged by visualization service(s) 1420 to generate visualizations. In at least one embodiment, rendering effects, such as ray-tracing, may be implemented by visualization service(s) 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1420 may include an internal visualizer, cinematics, and/or other rendering or image processing capabilities or functionality (e.g., ray tracing, rasterization, internal optics, etc.).

In at least one embodiment, hardware 1322 may include GPUs/Graphics 1422, AI system 1424, cloud 1426, and/or any other hardware used for executing training system 1304 and/or deployment system 1306. In at least one embodiment, GPUs/Graphics 1422 (e.g., NVIDIA's TESLA and/or QUADRO GPUs) may include any number of GPUs that may be used for executing processing tasks of compute service(s) 1416, AI service(s) 1418, visualization service(s) 1420, other services, and/or any of features or functionality of software 1318. For example, with respect to AI service(s) 1418, GPUs/Graphics 1422 may be used to perform pre-processing on imaging data (or other data types used by machine learning models), post-processing on outputs of machine learning models, and/or to perform inferencing (e.g., to execute machine learning models). In at least one embodiment, cloud 1426, AI system 1424, and/or other components of system 1400 may use GPUs/Graphics 1422. In at least one embodiment, cloud 1426 may include a GPU-optimized platform for deep learning tasks. In at least one embodiment, AI system 1424 may use GPUs, and cloud 1426—or at least a portion tasked with deep learning or inferencing—may be executed using one or more AI systems 1424. As such, although hardware 1322 is illustrated as discrete components, this is not intended to be limiting, and any components of hardware 1322 may be combined with, or leveraged by, any other components of hardware 1322.

In at least one embodiment, AI system 1424 may include a purpose-built computing system (e.g., a super-computer or an HPC) configured for inferencing, deep learning, machine learning, and/or other artificial intelligence tasks. In at least one embodiment, AI system 1424 (e.g., NVIDIA's DGX) may include GPU-optimized software (e.g., a software stack) that may be executed using a plurality of GPUs/Graphics 1422, in addition to CPUs, RAM, storage, and/or other components, features, or functionality. In at least one embodiment, one or more AI systems 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA's NGC) that may provide a GPU-optimized platform for executing processing tasks of system 1400. In at least one embodiment, cloud 1426 may include an AI system 1424 for performing one or more of AI-based tasks of system 1400 (e.g., as a hardware abstraction and scaling platform). In at least one embodiment, cloud 1426 may integrate with application orchestration system 1428 leveraging multiple GPUs to enable seamless scaling and load balancing between and among applications and services 1320. In at least one embodiment, cloud 1426 may tasked with executing at least some of services 1320 of system 1400, including compute service(s) 1416, AI service(s) 1418, and/or visualization service(s) 1420, as described herein. In at least one embodiment, cloud 1426 may perform small and large batch inference (e.g., executing NVIDIA's TENSOR RT), provide an accelerated parallel computing API and platform 1430 (e.g., NVIDIA's CUDA), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

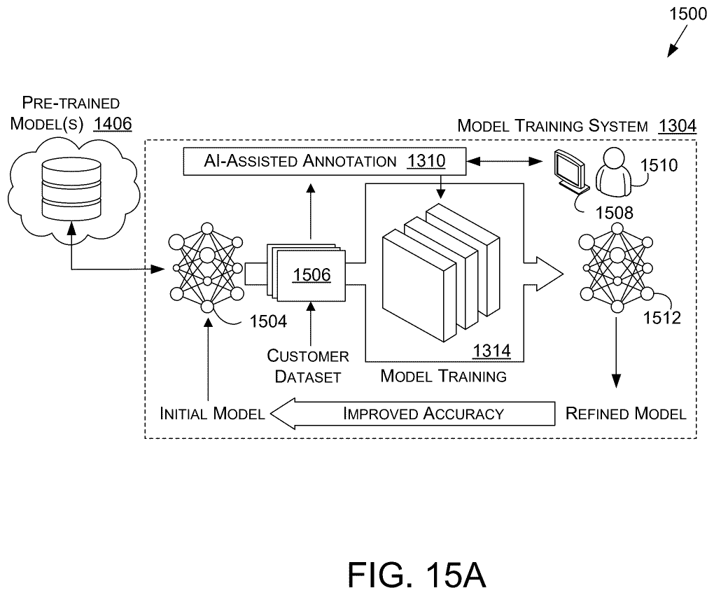

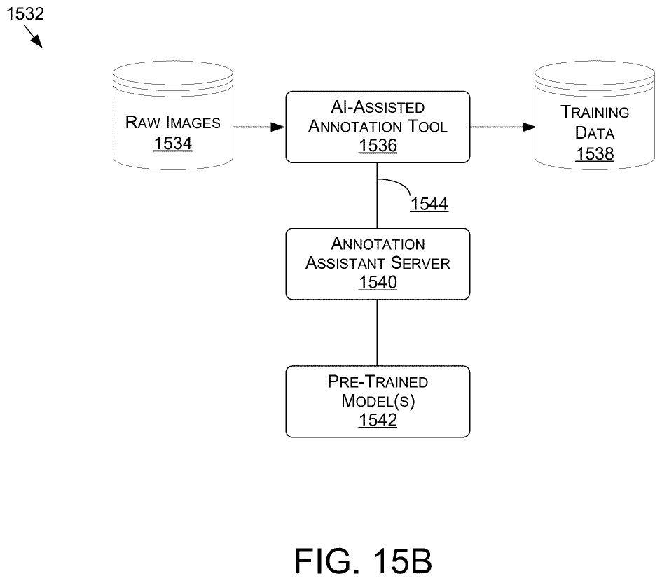

FIG. 15A illustrates a data flow diagram for a process 1500 to train, retrain, or update a machine learning model, in accordance with at least one embodiment. In at least one embodiment, process 1500 may be executed using, as a non-limiting example, system 1400 of FIG. 14. In at least one embodiment, process 1500 may leverage services and/or hardware as described herein. In at least one embodiment, refined models 1512 generated by process 1500 may be executed by a deployment system for one or more containerized applications in deployment pipelines.

In at least one embodiment, model training 1514 may include retraining or updating an initial model 1504 (e.g., a pre-trained model) using new training data (e.g., new input data, such as customer dataset 1506, and/or new ground truth data associated with input data). In at least one embodiment, to retrain, or update, initial model 1504, output or loss layer(s) of initial model 1504 may be reset, deleted, and/or replaced with an updated or new output or loss layer(s). In at least one embodiment, initial model 1504 may have previously fine-tuned parameters (e.g., weights and/or biases) that remain from prior training, so training or retraining 1514 may not take as long or require as much processing as training a model from scratch. In at least one embodiment, during model training 1514, by having reset or replaced output or loss layer(s) of initial model 1504, parameters may be updated and re-tuned for a new data set based on loss calculations associated with accuracy of output or loss layer(s) at generating predictions on new, customer dataset 1506.

In at least one embodiment, pre-trained models 1506 may be stored in a data store, or registry. In at least one embodiment, pre-trained models 1506 may have been trained, at least in part, at one or more facilities other than a facility executing process 1500. In at least one embodiment, to protect privacy and rights of patients, subjects, or clients of different facilities, pre-trained models 1506 may have been trained, on-premise, using customer or patient data generated on-premise. In at least one embodiment, pre-trained models 1506 may be trained using a cloud and/or other hardware, but confidential, privacy protected patient data may not be transferred to, used by, or accessible to any components of a cloud (or other off premise hardware). In at least one embodiment, where pre-trained models 1506 is trained at using patient data from more than one facility, pre-trained models 1506 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained models 1506 on-premise and/or off premise, such as in a datacenter or other cloud computing infrastructure.

In at least one embodiment, when selecting applications for use in deployment pipelines, a user may also select machine learning models to be used for specific applications. In at least one embodiment, a user may not have a model for use, so a user may select a pre-trained model to use with an application. In at least one embodiment, pre-trained model may not be optimized for generating accurate results on customer dataset 1506 of a facility of a user (e.g., based on patient diversity, demographics, types of medical imaging devices used, etc.). In at least one embodiment, prior to deploying a pre-trained model into a deployment pipeline for use with an application(s), pre-trained model may be updated, retrained, and/or fine-tuned for use at a respective facility.

In at least one embodiment, a user may select pre-trained model that is to be updated, retrained, and/or fine-tuned, and this pre-trained model may be referred to as initial model 1504 for a training system within process 1500. In at least one embodiment, a customer dataset 1506 (e.g., imaging data, genomics data, sequencing data, or other data types generated by devices at a facility) may be used to perform model training (which may include, without limitation, transfer learning) on initial model 1504 to generate refined model 1512. In at least one embodiment, ground truth data corresponding to customer dataset 1506 may be generated by training system 1304. In at least one embodiment, ground truth data may be generated, at least in part, by clinicians, scientists, doctors, practitioners, at a facility.

In at least one embodiment, AI-assisted annotation may be used in some examples to generate ground truth data. In at least one embodiment, AI-assisted annotation (e.g., implemented using an AI-assisted annotation SDK) may leverage machine learning models (e.g., neural networks) to generate suggested or predicted ground truth data for a customer dataset. In at least one embodiment, a user may use annotation tools within a user interface (a graphical user interface (GUI)) on a computing device.

In at least one embodiment, user 1510 may interact with a GUI via computing device 1508 to edit or fine-tune (auto) annotations. In at least one embodiment, a polygon editing feature may be used to move vertices of a polygon to more accurate or fine-tuned locations.

In at least one embodiment, once customer dataset 1506 has associated ground truth data, ground truth data (e.g., from AI-assisted annotation, manual labeling, etc.) may be used by during model training to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines at a facility for performing one or more processing tasks with respect to medical imaging data.

In at least one embodiment, refined model 1512 may be uploaded to pre-trained models in a model registry to be selected by another facility. In at least one embodiment, this process may be completed at any number of facilities such that refined model 1512 may be further refined on new datasets any number of times to generate a more universal model.

FIG. 15B is an example illustration of a client-server architecture 1532 to enhance annotation tools with pre-trained annotation models, in accordance with at least one embodiment. In at least one embodiment, AI-assisted annotation tool 1536 may be instantiated based on a client-server architecture 1532. In at least one embodiment, AI-assisted annotation tool 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (e.g., in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation, a deep learning model, for example, may receive this data as input and return inference results of a segmented organ or abnormality. In at least one embodiment, pre-instantiated annotation tools, such as AI-assisted annotation tool 1536 in FIG. 15B, may be enhanced by making API calls (e.g., API Call 1544) to a server, such as an Annotation Assistant Server 1540 that may include a set of pre-trained models 1542 stored in an annotation model registry, for example. In at least one embodiment, an annotation model registry may store pre-trained models 1542 (e.g., machine learning models, such as deep learning models) that are pre-trained to perform AI-assisted annotation on a particular organ or abnormality. These models may be further updated by using training pipelines. In at least one embodiment, pre-installed annotation tools may be improved over time as new labeled data is added.

Various embodiments can be described by the following clauses:
1. At least one processor, comprising:
one or more logical units to:
   obtain a signed distance function approximating a surface of a deformable object within a three-dimensional (3D) grid of cells;
   identify, based in part on scalar values associated with vertices of the cells according to the signed distance function, the cells of the 3D grid that contain a portion of the surface of the deformable object;
   infer, using a neural network taking the scalar values of the identified cells as input, a set of quadrature points falling inside a volume of the deformable object within the identified cells;
   perform, as part of a finite element analysis of the deformable object, integration over the set of quadrature points; and
   perform one or more differentiable elasticity simulations using behavior values determined from the finite element analysis.
2. The at least one processor of clause 1, wherein the one or more logical units are further to:
determine, using the neural network, a set of quadrature weights corresponding to the set of quadrature points; and
perform the integration further over the set of quadrature weights corresponding to the set of quadrature points.
3. The at least one processor of clause 1, wherein one or more logical units are further to:
generate the signed distance function to implicitly define the surface of the deformable object; and
update the signed distance function in response to changes in the surface of the deformable object determined during the finite element analysis.
4. The at least one processor of clause 3, wherein the one or more logical units are further to:
determine, in response to an update to the signed distance function and using the neural network, an updated set of quadrature points falling inside the volume of the deformable object within the identified cells as implicitly defined by the updated signed distance function.
5. The at least one processor of clause 1, wherein determining the set of quadrature points to fall inside the volume of the deformable object within an identified cell allows the identified cell to be treated as a conforming cell for the integration.
6. The at least one processor of clause 1, wherein the one or more logical units are further to:
simulate different elasticity values of different portions of the surface of the deformable object between respective pairs of quadrature points.
7. The at least one processor of clause 1, wherein the one or more logical units are further to:
perform interpolation with respect to the identified cells, that contain a portion of the surface of the deformable object, to determine an approximate location of the surface of the deformable object within the identified cells.
8. The at least one processor of clause 1, wherein the neural network includes at least one trained multilayer perceptron (MLP).
9. The at least one processor of clause 1, wherein the at least one processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative operations using a large language model (LLM);
a system for performing generative operations using a vision language model (VLM);
a system for performing generative operations using a multi-modal language model;
a system implemented using one or more microservices;
a collaborative content creation platform for 3D assets; or
a system implemented at least partially using cloud computing resources.
10. A system, comprising:
one or more processors to perform one or more simulations involving a deformable object by, in part, integrating over a set of quadrature points inferred by a neural network to fall inside a volume of the object, a surface of the object being implicitly defined using a signed distance function with respect to one or more vertices of a three-dimensional grid of cells in which the object is located.
11. The system of clause 10, wherein integration over the set of quadrature points is performed as part of a finite element analysis of the deformable object to provide a set of behavior values of the object for use in performing the one or more simulations.
12. The system of clause 10, wherein the one or more processors are further to:
determine, using the neural network, a set of quadrature weights corresponding to the set of quadrature points; and
perform the integrating further over the set of quadrature weights corresponding to the set of quadrature points.
13. The system of clause 10, wherein one or more processors are further to:
generate the signed distance function to implicitly define the surface of the object; and
update the signed distance function in response to deformation of the surface of the object determined during the one or more simulations.
14. The system of clause 10, wherein the neural network includes at least one trained multilayer perceptron (MLP).
15. The system of clause 10, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative operations using a large language model (LLM);
a system for performing generative operations using a vision language model (VLM);
a system for performing generative operations using a multi-modal language model;
a system implemented using one or more microservices;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets; or
a system implemented at least partially using cloud computing resources.
16. A simulation system, comprising:
a simulation environment to simulate physical behavior of at least one object;
a machine learning model to infer a set of quadrature points falling inside a volume of the at least one object and
one or more processors to:
   obtain a signed distance function approximating a surface of a deformable object, of the at least one object, within a three-dimensional (3D) grid of cells;
   identify, based in part on scalar values associated with vertices of the cells according to the signed distance function, the cells of the 3D grid that contain a portion of the surface of the deformable object;
   infer, using a neural network taking the scalar values of the identified cells as input, the set of quadrature points falling inside the volume of the deformable object within the identified cells;
   perform, as part of a finite element analysis of the deformable object, integration over the set of quadrature points; and
   perform, within the simulation environment, one or more differentiable elasticity simulations using behavior values determined from the finite element analysis.
17. The simulation system of clause 16, wherein the one or more processors are further to:
determine, using the neural network, a set of quadrature weights corresponding to the set of quadrature points; and
perform the integration further over the set of quadrature weights corresponding to the set of quadrature points.
18. The simulation system of clause 16, wherein the one or more processors are further to:
generate the signed distance function to implicitly define the surface of the deformable object; and
update the signed distance function in response to changes detected for the deformable object determined during the finite element analysis.
19. The simulation system of clause 16, wherein the one or more processors are further to:
simulate different elasticity values of different portions of the surface of the deformable object between respective pairs of quadrature points.
20. The simulation system of clause 16, wherein the simulation system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative operations using a large language model (LLM);
a system for performing generative operations using a vision language model (VLM);
a system for performing generative operations using a multi-modal language model;
a system implemented using one or more microservices;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets; or
a system implemented at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. At least one processor, comprising:
one or more logical units to:
obtain a signed distance function approximating a surface of a deformable object within a three-dimensional (3D) grid of cells;
identify, based in part on scalar values associated with vertices of the cells according to the signed distance function, the cells of the 3D grid that contain a portion of the surface of the deformable object;
infer, using a neural network taking the scalar values of the identified cells as input, a set of quadrature points falling inside a volume of the deformable object within the identified cells;
perform, as part of a finite element analysis of the deformable object, integration over the set of quadrature points; and
perform one or more differentiable elasticity simulations using behavior values determined from the finite element analysis.

2. The at least one processor of claim 1, wherein the one or more logical units are further to:
determine, using the neural network, a set of quadrature weights corresponding to the set of quadrature points; and
perform the integration further over the set of quadrature weights corresponding to the set of quadrature points.

3. The at least one processor of claim 1, wherein one or more logical units are further to:
generate the signed distance function to implicitly define the surface of the deformable object; and
update the signed distance function in response to changes in the surface of the deformable object determined during the finite element analysis.

4. The at least one processor of claim 3, wherein the one or more logical units are further to:
determine, in response to an update to the signed distance function and using the neural network, an updated set of quadrature points falling inside the volume of the deformable object within the identified cells as implicitly defined by the updated signed distance function.

5. The at least one processor of claim 1, wherein determining the set of quadrature points to fall inside the volume of the deformable object within an identified cell allows the identified cell to be treated as a conforming cell for the integration.

6. The at least one processor of claim 1, wherein the one or more logical units are further to:
simulate different elasticity values of different portions of the surface of the deformable object between respective pairs of quadrature points.

7. The at least one processor of claim 1, wherein the one or more logical units are further to:
perform interpolation with respect to the identified cells, that contain a portion of the surface of the deformable object, to determine an approximate location of the surface of the deformable object within the identified cells.

8. The at least one processor of claim 1, wherein the neural network includes at least one trained multilayer perceptron (MLP).

9. The at least one processor of claim 1, wherein the at least one processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a system for performing generative operations using a large language model (LLM);
a system for performing generative operations using a vision language model (VLM);
a system for performing generative operations using a multi-modal language model;
a system implemented using one or more microservices;
a collaborative content creation platform for 3D assets; or
a system implemented at least partially using cloud computing resources.

10. A system, comprising:
one or more processors to perform one or more simulations involving a deformable object by, in part, integrating over a set of quadrature points inferred by a neural network to fall inside a volume of the object, a surface of the object being implicitly defined using a signed distance function with respect to one or more vertices of a three-dimensional grid of cells in which the object is located.

11. The system of claim 10, wherein integration over the set of quadrature points is performed as part of a finite element analysis of the deformable object to provide a set of behavior values of the object for use in performing the one or more simulations.

12. The system of claim 10, wherein the one or more processors are further to:
determine, using the neural network, a set of quadrature weights corresponding to the set of quadrature points; and
perform the integrating further over the set of quadrature weights corresponding to the set of quadrature points.

13. The system of claim 10, wherein one or more processors are further to:
generate the signed distance function to implicitly define the surface of the object; and
update the signed distance function in response to deformation of the surface of the object determined during the one or more simulations.

14. The system of claim 10, wherein the neural network includes at least one trained multilayer perceptron (MLP).

15. The system of claim 10, wherein the system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative operations using a large language model (LLM);
a system for performing generative operations using a vision language model (VLM);
a system for performing generative operations using a multi-modal language model;
a system implemented using one or more microservices;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets; or
a system implemented at least partially using cloud computing resources.

16. A simulation system, comprising:
a simulation environment to simulate physical behavior of at least one object;
a machine learning model to infer a set of quadrature points falling inside a volume of the at least one object and
one or more processors to:
obtain a signed distance function approximating a surface of a deformable object, of the at least one object, within a three-dimensional (3D) grid of cells;
identify, based in part on scalar values associated with vertices of the cells according to the signed distance function, the cells of the 3D grid that contain a portion of the surface of the deformable object;
infer, using a neural network taking the scalar values of the identified cells as input, the set of quadrature points falling inside the volume of the deformable object within the identified cells;
perform, as part of a finite element analysis of the deformable object, integration over the set of quadrature points; and
perform, within the simulation environment, one or more differentiable elasticity simulations using behavior values determined from the finite element analysis.

17. The simulation system of claim 16, wherein the one or more processors are further to:
determine, using the neural network, a set of quadrature weights corresponding to the set of quadrature points; and
perform the integration further over the set of quadrature weights corresponding to the set of quadrature points.

18. The simulation system of claim 16, wherein the one or more processors are further to:
generate the signed distance function to implicitly define the surface of the deformable object; and
update the signed distance function in response to changes detected for the deformable object determined during the finite element analysis.

19. The simulation system of claim 16, wherein the one or more processors are further to:
simulate different elasticity values of different portions of the surface of the deformable object between respective pairs of quadrature points.

20. The simulation system of claim 16, wherein the simulation system comprises at least one of:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative operations using a large language model (LLM);
a system for performing generative operations using a vision language model (VLM);
a system for performing generative operations using a multi-modal language model;
a system implemented using one or more microservices;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a data center;
a system for performing hardware testing using simulation;
a system for synthetic data generation;
a collaborative content creation platform for 3D assets; or
a system implemented at least partially using cloud computing resources.
